(19) United States
(12) Patent Application Publication
(10) Pub. No.: US 2017/0366342 A1
(43) Pub. Date: Dec. 21, 2017

(54) Protecting the Integrity of Log Entries in a Distributed System

(71) Applicant: PCMS Holdings, Inc., Wilmington, DE (US)

(72) Inventor: Christian M. Gehrmann, Lund (SE)

(73) Assignee: PCMS Holdings, Inc., Wilmington, DE (US)

(21) Appl. No.: 15/532,833

(22) PCT Filed: Dec. 4, 2015
(86) PCT No.: PCT/US2015/063998

§ 371 Date: Jun. 2, 2017

Related U.S. Application Data
(60) Provisional application No. 62/088,275, filed on Dec. 5, 2014.

(51) Int. Cl. H04L 9/08; H04L 29/08

(52) U.S. Cl. CPC H04L 9/0822; H04L 9/0894; H04L 9/0861; H04L 67/10

(57) ABSTRACT

Systems, methods, and instrumentalities are disclosed for integrity protecting log entries generated from a first unit in a distributed system. For example, a first secret key may be received or obtained from a central management system and storing the first secret key in non-volatile memory. A second secret key may be calculated where the second secret key may be shared with a plurality of units within the same local communication domain as a unit using a secure key calculation. The second secret key may further be stored in volatile memory. The first and second keys may be used to calculate a first secret integrity protection key and a first broadcast encryption key. A security sensitive log entry may be generated and may be protected using the first integrity key and the first broadcast encryption key. The log entry may be broadcast to the plurality of units within the domain.

### CROSS-REFERENCE TO RELATED APPLICATIONS

This application claims the benefit of U.S. Provisional Application No. 62/088,275, filed Dec. 5, 2014, the disclosure of which are incorporated herein by references in their entirety.

### BACKGROUND

Distributed systems with interconnected computing units (e.g., or M2M units) built upon shared general IP-based infrastructures may be utilized, for example, in place of isolated physical data networks and control systems. Distributed systems with interconnected computing units may save costs and may add flexibility.

### SUMMARY

Systems, methods, and instrumentalities are disclosed for integrity protecting log entries generated from a first unit in a distributed system. Log entries may be protected by obtaining a first secret key from a central management system and storing the first secret key in non-volatile memory. Log entries may further be protected by calculating a second secret key, where the second secret key may be shared with a plurality of units within the same local communication domain as a unit using a secure key calculation, and where the second secret key may be stored in volatile memory. Log entries may be protected by using the first and second keys to calculate a first secret integrity protection key. Log entries may be protected by using the second key to calculate a first broadcast encryption key. Log entries may be protected by generating a security sensitive log entry. Log entries may be protected by protecting an integrity of the security sensitive log entry using the first integrity key (e.g., where the integrity of the security sensitive log may be configured to be protected using a message authentication code derived using the first integrity key. Log entries may be protected by protecting the integrity protected sensitive log entry using the first broadcast encryption key (e.g., where the integrity protected sensitive log entry is configured to be protected by encryption using the first broadcast encryption key). Log entries may be protected by broadcasting the encrypted and integrity protected sensitive log entry the plurality of units within the domain using a suitable broadcast message passing method.

In examples, log entries may further be protected using a third key. For example, one or more shares may be received, broadcasted to additional units within a domain and/or shared therewith. Using a secret sharing scheme, a third key (e.g., that may replace and provide the same or similar function of the second key, for example, in encryption and may be derived or generated upon power failure and/or reboot) may be calculated or generated based on the one or more shares and may be stored in volatile memory.

### BRIEF DESCRIPTION OF THE DRAWINGS

FIG. 1 illustrates an example distributed system view.

FIG. 2 illustrates an example industrial control system.

FIG. 3 illustrates an example distributed physical access control system (PACS).

FIG. 4 illustrates distributed video surveillance system.

FIG. 5 illustrates an example automotive system.

FIG. 6 illustrates an example ship system.

FIG. 7 illustrates an example storage.

FIG. 8 illustrates an example secure system setup.

FIG. 9 illustrates an example system restore/reboot.

FIG. 10 illustrates an example device set up for a distributed system.

FIG. 11A illustrates a GD update procedure for a distributed system.

FIG. 11B illustrates a GD update procedure for a distributed system.

FIG. 12A illustrates an example of adding a unit to an existing installation.

FIG. 12B illustrates an example of adding a unit to an existing installation.

FIG. 13 illustrates an example syslog signature block format

FIG. 14 illustrates an example log protection

FIG. 15 illustrates an example of distributed system log protection.

FIG. 16 is an example flowchart for distributed system log protection.

FIG. 17 illustrate an example system deployment for distributed system log protection.

FIG. 18 illustrates an example secure log principle.

FIG. 19 illustrates an example log collection and local memory clean up.

FIG. 20 illustrates an example system recovery procedure.

FIG. 21 illustrates an example system in which examples herein may be implemented.

FIG. 22A is a system diagram of an example communications system in which one or more disclosed embodiments may be implemented.

FIG. 22B is a system diagram of an example wireless transmit/receive unit (WTRU) that may be used within the communications system illustrated in FIG. 22A.

FIG. 22C is a system diagram of an example radio access network and an example core network that may be used within the communications system illustrated in FIG. 22A.

FIG. 22D is a system diagram of another example radio access network and another example core network that may be used within the communications system illustrated in FIG. 22A.

FIG. 22E is a system diagram of another example radio access network and another example core network that may be used within the communications system illustrated in FIG. 22A.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application.

Distributed systems with interconnected computing units (e.g., or M2M units) built upon shared general IP-based infrastructures may be utilized, for example, in place of isolated physical data networks and control systems. In examples, such distributed systems with interconnected computing units may save costs, may add flexibility, and may result in less robust and more sensitive systems (e.g., in terms of vulnerability). Examples disclosed herein may apply to a wide range of systems such as for instance industrial control systems, video surveillance systems, physical access control systems, automotive systems, ship systems, etc.

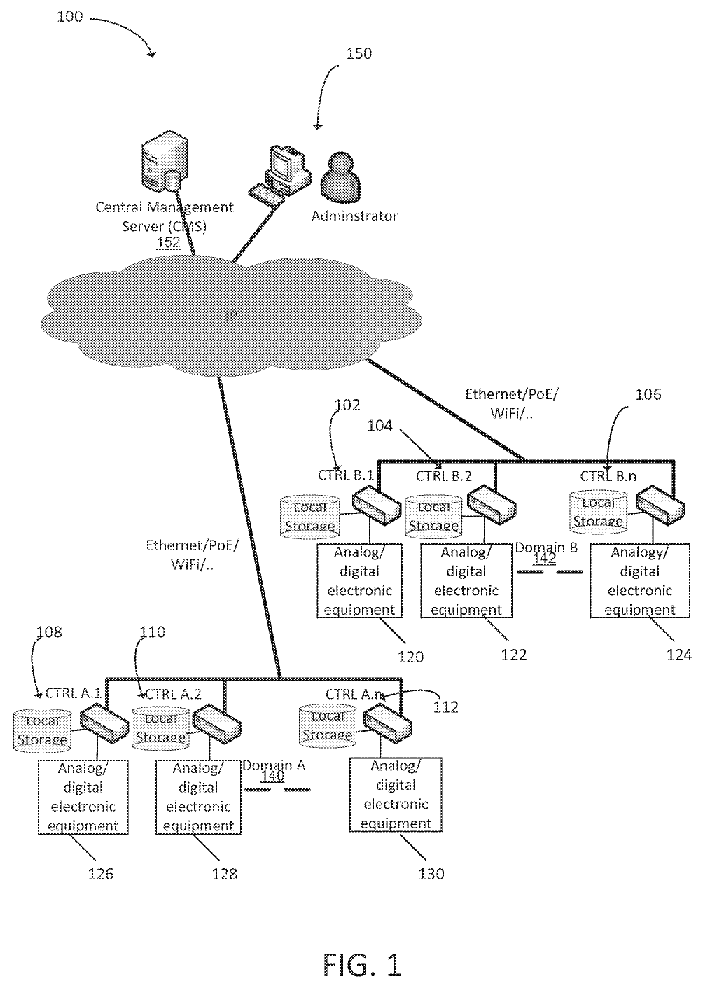

FIG. 1 illustrates an example distributed system 100 that may be provided in one or more examples herein. The systems such as the system 100 describe herein may be completely or partly constructed using a distributed network structure (e.g., as illustrated in FIG. 1). As shown, in the system 100, one or more control units (CTRLs) CTRL 102/104/106/108/110/112 may be interconnected in a local IP based network that also have global connectivity.

The one or more (e.g., each) CTRL 102/104/106/108/110/112 may control one or more local analog or digital equipment units 120/122/124/126/128/130. The local analog or digital equipment units 120/122/124/126/128/130 may be specific for the particular application. To simplify deployment and management, one or more (e.g., each) CTRL 102/104/106/108/110/112 may have local storage capabilities, for example, where one or more (e.g., all) domain and/or system wide information may be stored. The distributed system 100 may be symmetric, for example, such that one or more (e.g., each) CTRL 102/104/106/108/110/112 within a domain 140/142 (e.g., single domain) may share basic management and/or distributed database functionality. In an example, one or more of the CTRLs 102/104/106/108/110/112 or a new or additional CTRL may (e.g., without major system reconfigurations) be added or removed from the system 100. Further, one or more CTRLs 102/104/106/108/110/112 may be connected in a local physical network, such as Ethernet, Power over Ethernet (PoE), WiFi, Bluetooth, Zigbee, via connection (e.g., 145a/145b).

As shown in FIG. 1, one or more (e.g., all) CTRLs 102/104/106/108/110/112 within a domain 140/142 may be located in, for example, a separate geographic location, building or part of a building, vehicle, vessel, and/or the like. In examples, the CTRLs 102/104/106/108/110/112 within a domain 140/142 may be located relatively close to each other and may be able to communicate with each other through reliable fixed or wireless communication links. A complete distributed system 100 may comprise one or more domains 140/142 of connected (e.g., closely connected) CTRLs 102/104/106/108/110/112. FIG. 1 illustrates domain A and domain B (e.g., 140/142 respectively) although additional domains may be provided and/or used.

The domains 140/142 may be connected with a central administration unit 150 that may administrate the system 100 and/or configure the CTRLs 102/104/106/108/110/112, for example, with respect to application configurations and/or security credentials, etc. For example, in systems covering several sites, vehicles, vessels, large buildings or properties, the administration may be done remotely far from the local systems where the CTRLs may be deployed.

There may be a risk that the connection between the different domains (e.g., 140 and 142) and/or the central unit from time to time may be broken such that the system 100 may not rely on it for full network connectivity with the central administration unit. In examples, the system 100 may be less secure and/or more sensitive to attacks if the system becomes unusable due to the network connection with the central system being broken. As such, in examples, a central unit (e.g., CMS 152 in FIG. 1) and the system sensitive information may be physically protected, for example, using user credentials, local security policies (e.g., local to the domain or CTRL) and logs.

Examples herein (e.g., a robust solution) may not completely rely on connectivity with a central server. Examples herein may work in times of temporary or longer network down periods and may work as quickly as possible after a temporary power loss. For example, sensitive information, such as end user credentials, administration credentials, local security policies and logs, may be possible to manage in a secure way locally within a single domain when network connectivity to the central unit is lost. Loss of a single or a limited number of CTRLs such as 102/104/106 in domain 142 and/or 108/110/112 in domain 140 may not compromise the security of the system 100. For example, a set of end user credentials, access logs or local security policies that may have a high risk of being stolen or being modified by an attacker may be secure. For example, the example systems and methods herein may provide a high security level despite a set of end user credentials, access logs or local security policies being stolen (e.g., improving security). One or more CTRL security configurations may be managed with little manual effort (i.e., one or more of the CTRL security configurations can be managed remotely without any need for direct manual configurations on the devices.). Further, in examples herein, a key management method or process (e.g., routine) may not depend on platform hardware security functions, for example, because depending on platform hardware security may make the system more expensive to manufacture and manage.

In one or more examples, a robust and secure management of system keys and databases in a distributed IP based system may be described herein. Further, different applications that may be used in one or more examples may be described herein. The examples and embodiments described herein may not be limited to the particular contexts in which they are described. For example, each combination of different CTRLs for different applications domain may apply to embodiments described herein.

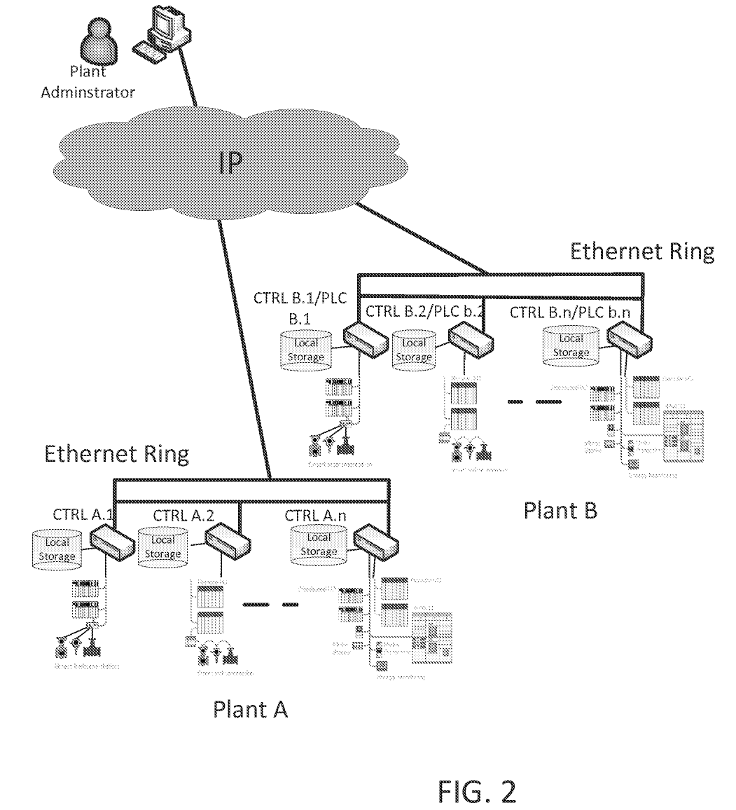

FIG. 2 illustrates an example industrial control system 200. The examples described herein may be utilized in industrial control systems. In industrial control systems, plant, process and the field layers may be distinguished. For example, in the process layer, modern industrial control systems may use IP based control units, such as Programmable Logic Controllers (PLCs). The PLCs in industrial control systems may map onto the CTRLs 102/104/106/108/110/112 respectively, for example, in a distributed system architecture that may be illustrated in FIG. 2.

For example, the examples described herein may be utilized in physical access control systems. Some Physical Access Control Systems (PACS) may utilize online lock controllers and/or access control servers, for example, while the end-user device for getting physical access (e.g., access cards, PIN, mobile phones with NFC, and/or the like) may operate off-line. One or more PACS may be described herein. Further, examples herein may use a ONVIF profile C standard, which may be a security way to standardize the management interface towards a PACS control unit.

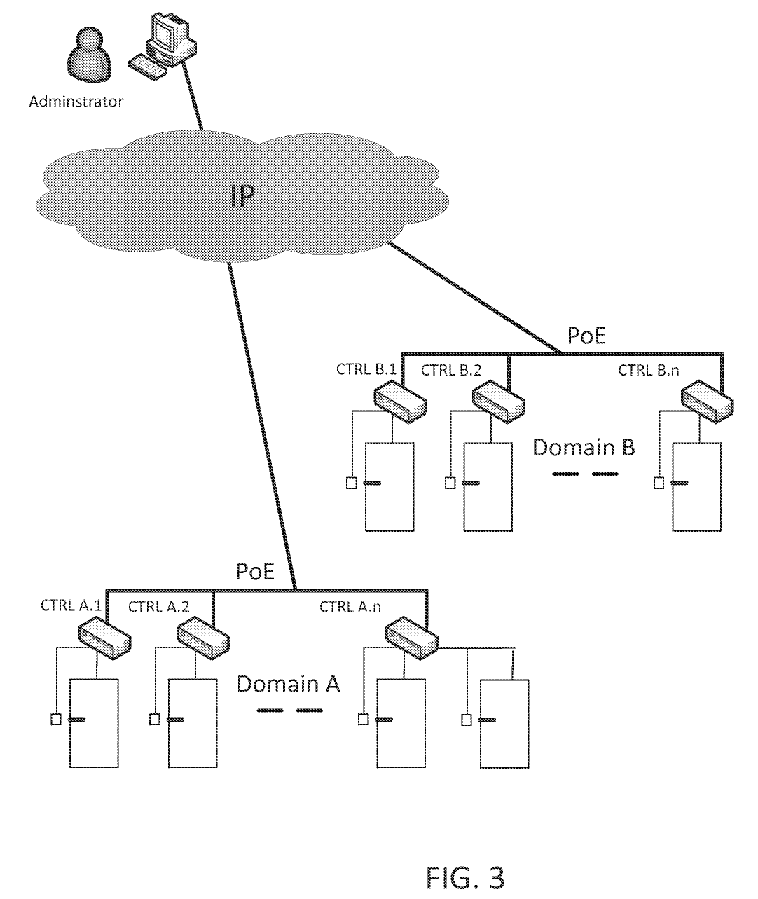

The Axis A1001 may be an example of an ONVIF compliant PACS product that may be used as one or more of the CTRLs as described herein. The A1001 may be an example of a distributed IP-based PACS in accordance with examples described herein. The security of A1001 may be based on a simple administrator password used to protect a global user access control database. The A1001 may use a similar setup as examples described herein. Examples described herein may be utilized for security (e.g., with PACS or CTRLs) to avoid the steel or compromise of a single unit that may have the risk of compromising the security of the whole system. FIG. 3 illustrates an example distributed physical access control system (PACS) 300 that may implement one or more of the examples herein. One or more (e.g., each) CTRLs unit in FIG. 3 may have persistence storage capabilities such that they can store log data also in case of temporary power loss. FIG. 3 may map (e.g., map directly including reference numerals and named elements) to the distributed system (e.g., 100) as described herein.

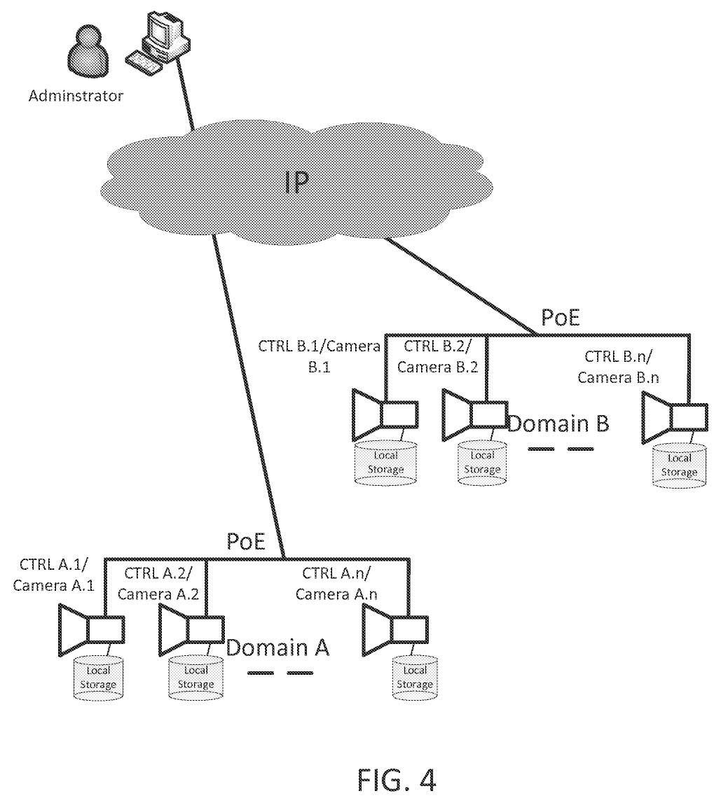

FIG. 4 illustrates distributed video surveillance system 400 that may implement one or more of the examples herein. The examples described herein may be utilized in video surveillance systems. Video surveillance systems may be centrally managed and/or controlled or based on a distributed architecture. A distributed video surveillance system with one or more geographically distributed physical domains may be depicted in FIG. 4. FIG. 4 may map (e.g., map directly including reference numerals and named elements) to the distributed system (e.g., 100) as described herein.

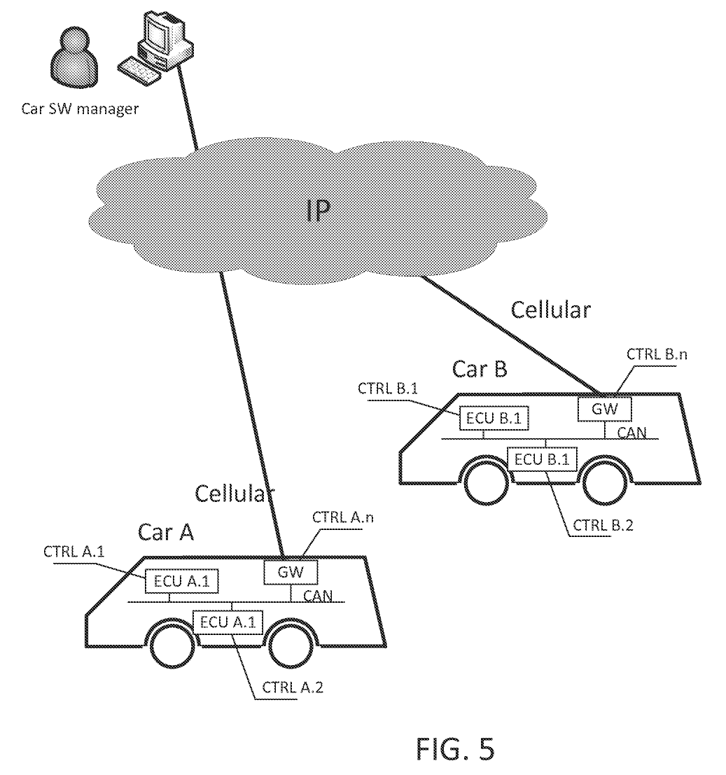

FIG. 5 illustrates an example automotive system 500 that may implement one or more of the examples herein. The examples described herein may be utilized in automotive systems. A modern car may include a number of Electronic Control Units (ECUs) that may control one or more car functions and/or other care services. A number of these devices may have Internet connectivity and may communicate using the Controller Area Network (CAN) bus communication technology. A number of ECUs may communicate over an IP based network. The ECUs in an automotive system may be mapped onto the CTRL-based distributed architecture described herein. Vehicles may be a domain, for example, as depicted in FIG. 5. The ECU, gateway (GW) units, etc. may have persistent local storage capabilities for instance flash memories. In an automotive system, one or more (e.g., most) of the CTRLs/ECUs may be in sleep mode, for example, when the car is parked and needs to be waked up each time the car is used. FIG. 5 may map (e.g., map directly including reference numerals and named elements) to the distributed system (e.g., 100) as described herein.

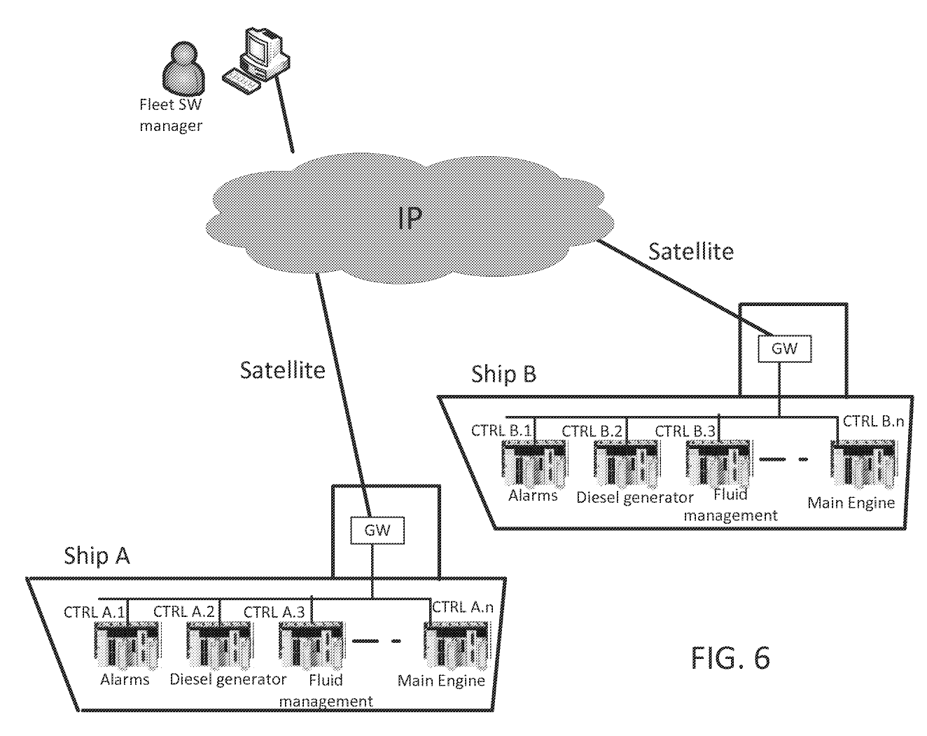

FIG. 6 illustrates an example ship system 600 that may implement one or more examples herein. For example, commercial ship IT systems may use primitive systems with limited connection capabilities. As global connectivity allows enhanced functionality, such as dynamic software upgrade and configuration, lower maintenance costs and better global supervision of fleets, etc., commercial ship IT systems may stop using primitive systems. A fleet control system that maps to the examples described herein may be illustrated in FIG. 6. FIG. 6 may map (e.g., map directly including reference numerals and named elements) to the distributed system (e.g., 100) as described herein.

In one or more examples, a secret sharing scheme (e.g., method or technique) may be used as described herein. A secret sharing scheme may be utilized, for example, when a secret value is given to a single user. T may be a trusted party that may be responsible for generating and securely distributing different shares to participants. The sharing of a secret value S among n participants may utilize the following:
T: Selects n−1 random values Sᵢ, 0≦Sᵢ≦l−1, where l is the integer size of the secret S.
T: Gives one or more (e.g., each) participant, Pᵢ, 1≦i≦n−1, the secret Sᵢ
T: Gives participant Pₙ, the share Sₙ=S−Σᵢ₌₁ⁿ⁻¹ Sᵢ mod
   When one or more (e.g., all) users pool their shares, the secret S may be calculated as:

Σᵢ₌₁ⁿSᵢ mod l.

A Shamir threshold secret sharing scheme, S(k,n) may be used in one or more examples described herein. In a threshold secret sharing, a secret values S may be divided among n participant, for example, such that the secret value may be calculated if at least t out of n participants pool their shares together. An example secret sharing is Shamir's S(k,n) threshold, shown below:
T: May chooses a prime p>max(S,n) and let a₀=S
T: May selects k−1 random independent coefficients,

a₁, . . . ,aₖ₋₁,0≦aⱼ≦p−1. Let f(x)=Σⱼ₌₀^{k-1}aⱼx^{j} over [symbol] ₚ
T: May give participant i the share Sᵢ={f(i), i}={sᵢ, i}

The Lagrange interpolation formula may be utilized to recover the secret for at least k participants, (x₁, x₂, . . . , xₖ):

$$S = {\sum }_{i = 0}^{k} {c}_{i} {s}_{i} where {c}_{i} = {\prod }_{1 \leq j \leq k , j \neq i}^{ } \frac{{x}_{j}}{{x}_{j} - {x}_{i}} .$$

A threshold group signature scheme, G(k,n) may be used in one or more examples described herein. Examples described herein may be based (e.g., partially based) on group signature schemes. Such schemes may be considered where at least k out of n participants may be able to together calculate a valid signature of a message through joint efforts and k−1 and less participants are not able to calculate a signature. For example, in this scheme, a signature of a single message may not enable an adversary in control of k−1 participants to obtain the secret signing parameters or to sign chosen messages. k out of n threshold group signature scheme may be denoted by G(k,n). An RSA based scheme may be the Shoup threshold signature scheme. The principles (e.g., basic principles) of this scheme may be G(k,n) Setup, G(k,n) signature share calculation, and/or G(k,n) calculation of final RSA signature.

In G(k,n) Setup T may select secret RSA parameters, p=2p′+1, q=2q′+1 and may allow the public RSA parameter \hat{n}=pq. T may selects a public exponent e as a prime, e>n, and may compute a secret exponent d such that d≡1 mod p′q′. For the group of participants G, the private group key may be denoted by Pr_{G}=(\hat{n},d) and the public key may be denoted by Pb_{G}=(\hat{n},e). T may sets S=d and may use Shamir threshold scheme and replace the prime parameter p with the prime product pq. T may use this scheme to calculate individual shares to one or more (e.g., all) participants. The secret share of participants i in the group may be denoted by sᵢ=Pr_{Gi}. [symbol] _{\hat{n}} may denoted the subgroup of squares in [symbol] _{\hat{n}}. T may choose a random value vε [symbol] _{\hat{n}}, and, for 1≦i≦n, may compute the public key Pk_{Gi} of participant i as Pk_{Gi}=v, v^{s}^{ᵢ}ε [symbol] _{\hat{n}}. The public key value may allow other participants to check, for example, if a particular signature share is from the expected participant or not.

In G(k,n) signature share calculation, one or more (e.g., each) participant may calculate its signature share, yᵢ, of message m as: yᵢ=m^{2n!s}^{ᵢ}ε [symbol] _{\hat{n}} and may calculate a proof of correctness using PK_{Gi}.

In G(k,n) calculation of final RSA signature, there may be k participants, (x₁, x₂, . . . , xₖ) and

$${\hat{c}}_{i} = n ! {\prod }_{1 \leq j \leq k , j \neq i}^{ } \frac{{x}_{j}}{{x}_{j} - {x}_{i}} .$$

A combiner may calculates w=Π_{1≦j≦k}yₓ_{ᵢ}^{2ĉ}^{ᵢ} and may use the Euclidian algorithm to find the signature y=w^{a}x^{b} (=x^{d}), where a and b may be integers such that 4(n!)²a+eb=1. 4(n!)²a+eb=1 may be found using gcd(4(n!)²,)=1.

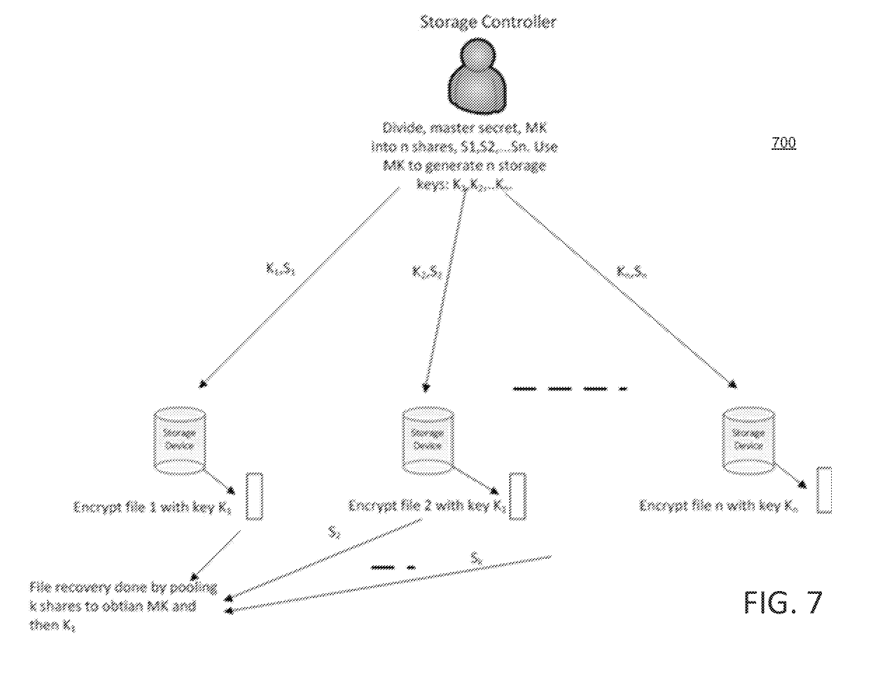

FIG. 7 illustrates an example method or technique 700 of securing storage that may be used for the protection of data stored on local host based on secret sharing technique or method in one or more examples herein. The keys used to encrypt a local file in examples herein may be derived from a master secret that can only be obtained if at least k out of n of the storage units pools their secret shares together. For example, as shown in FIG. 7, a master secret may be used to protect a set of distributed storage devices (e.g., the CTRLs such as 102/104/106 and/or 108/110/112 described herein). The master secret may be stored in pieces, for example, using a secret sharing scheme or method (e.g., An example of this secret sharing scheme may include a master secret MK being shared among n participants such that at least k out of these participants must pool their shares in order for them to recover MK). The master secret may be obtained (e.g., may received) by the storage devices, for example, if certain number of storage devices (e.g., k or more of n storage devices) pool their shares together to obtain the master secret used to derive the storage specific keys.

The master key may be shared on a set of distributed units (e.g., the CTRLs described herein) with storage capacity. Further, in examples, domain specific master keys used to protect system-wide and local databases may be shared. Secret sharing techniques or methods (e.g., as described herein, for example, above) may be utilized for secure generation, update and reconstruction of a system-wide database. Administrative procedures (e.g., complete administrative procedures) for a trusted system administrator for the secure generation of keys and databases may be described herein.

Mobile ad hoc network (MANET) secure join and leave may be used in one or more examples described herein. MANET join and leave may be about how the different NODES in the MANET agrees on how to accept or refuse a new member (node) to join the MANET. In the examples herein, threshold cryptography may be used for the nodes to JOINTLY make such decisions. Client ad hoc network join and leave based on distributed group control may be allowed. The join process may not be controlled by a single node in the ad hoc network. The join process may be controlled by a group of controller nodes. At least k out of n of the controller nodes may be utilized for a client to join or leave the ad hoc group. Threshold cryptographic schemes may be used with threshold signatures that may be used to agree on the set of member nodes in the MANET. Threshold cryptographic schemes or methods may be used with a threshold key generation scheme that may be used to generate group member keys that may be used by the member nodes to protect the ad hoc group communication. The threshold cryptographic schemes or methods may be used with a fixed distributed system, for example, to protect system-wide secrets in a local land access network (LAN). A fixed distributed system utilizing threshold cryptographic schemes to protect system-wide secrets in a local LAN may be described herein. Threshold signatures may be used to agree on a valid dataset. Protected database management in distributed systems may be described herein.

A secure and/or robust distributed system where the system administrator at system setup assigns a set of CTRLs into a particular domain may be described herein and may implement one or more of the examples herein. These domains may be chosen so that one domain constitutes one or more (e.g. all) CTRLs within the same physical network with robust network connectivity. Examples described herein may utilize a system-wide distrusted database. The database may be stored using the local storage capabilities for one or more (e.g., each) CTRL in the system. One database may be global and valid for one or more (e.g., all) different domains. Another database (e.g., 160 and/or 162) may be valid within a single domain. A system global database may be referred to as the general database. The domain specific database may be referred to as the local database.

Further, a key management model may be implemented in the examples herein. The key management model may include a specific master key per domain. This key can in turn be used to confidentiality protect the system general database. We denote this key for domain a by MKA. This key can in turn also be used to derive domain specific keys to protect other domain assets such as the local databases as well as access log information etc. For management purposes, the system (e.g., 100) may include or have each CTRL in the domain store a local copy of this encrypted and integrity protected database in non-volatile memory.

The domain specific master key, MKA, may not be stored (e.g., stored permanently) on the CTRLs in the domain. The domain specific maser key, MKA, may be stored (e.g., stored permanently) at system setup. The domain specific master key may be shared with the help of a system administrator among the different CTRLs in the domain, for example, using a secret sharing scheme such that at least k out of n CTRLs may co-operate to obtain the domain specific key used to obtain the clear text version of the credential database and deriving the other domain specific keys. High protection of the maser key may be provided while avoiding the use of expensive CTRL platform hardware security functions and/or configurations to protect a stored version of MKA. Automatic or almost automatic distributed key management within a domain may be allowed, for example, instead of a specific additional security scheme.

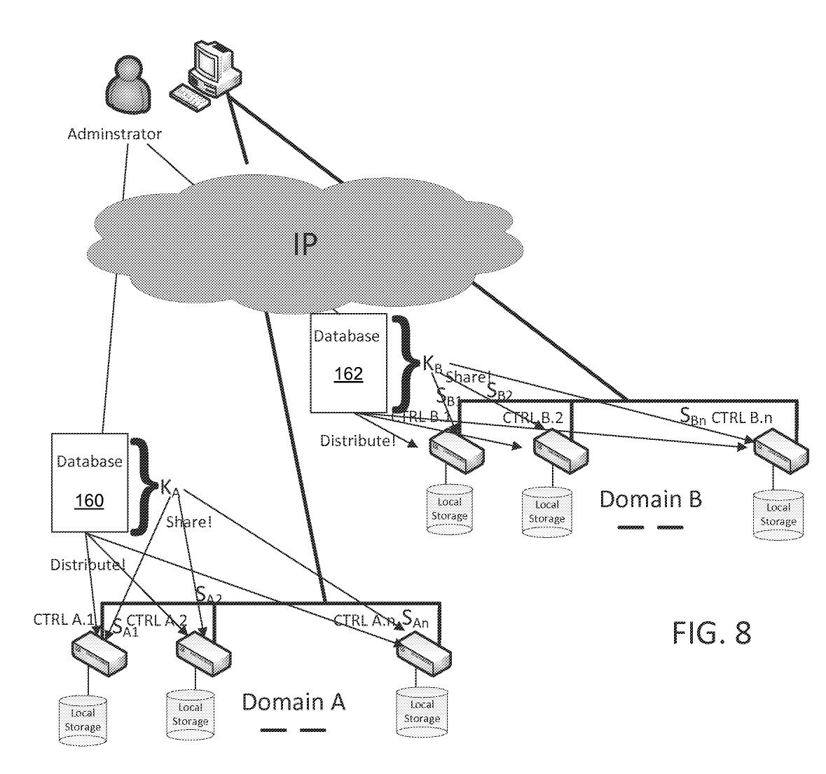

FIG. 8 illustrates an example secure system setup for a system 100 according to examples herein. For example, in examples described herein, at system deployment, one or more (e.g., all) CTRLs (e.g., that may map to the CTRLs 102/104/106 and/or 108/110/112 in FIG. 1) in a domain (e.g., respectively 140 and/or 142 in FIG. 1) may be given a secure association (e.g., based on symmetric or public keys), such that the domain may be securely allowed to authenticate/identify one or more (e.g., all) units within the domain and setup secure channels with one or more (e.g., all) other units in the domain. One or more (e.g., all) CTRLs in a domain given a secure association may allow the units to securely pool their secret shares, for example, when a database (e.g., 160 and/or 162) may be accessed.

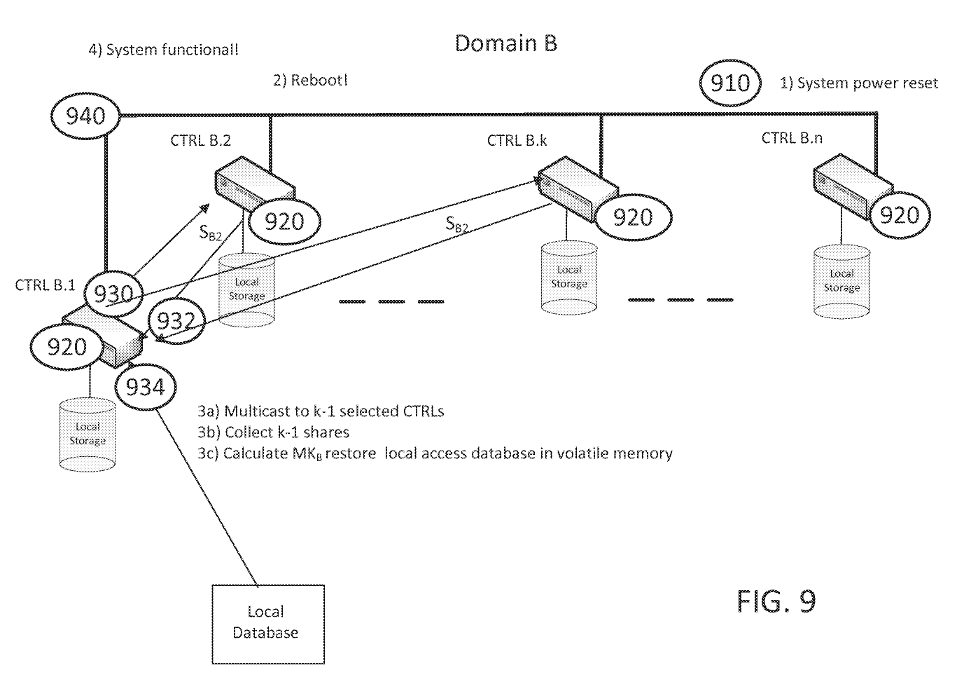

FIG. 9 illustrates an example restore/reboot in the system 100 (e.g., in domain 142 thereof but also applicable to domain 140). At system boot after power loss or building/vehicle/vessel maintenance, the different CTRLs (e.g., 102/104/106) in a domain (e.g., 142) may use a dedicated system setup protocol to derive the MKB, which may be derived by letting the different CTRLs pool their respectively secrets together according to a suitable secret sharing scheme such that MKA may be determined or obtained. In such an example, the different CTRLs in the domain may be able to derive the remainder of the domain specific keys and may load the whole and/or parts of the credential database into protected volatile memory. This may be done in a secure and/or distributed way without the use of a connection to a central management system. At system operation, the databases may be used by the CTRL to perform the application specific tasks in the system. For example, at 910, the system may have a power reset. At 920, the system may reboot. At 930, the system may multicast (e.g., their secret share used to derive MKA) to k−1 selected CTRLs. At 932, a CTRL may collect or receive k−1 shares. The shares may be the individual secrets that may have been distributed to the different CTRLS using the agreed secret sharing scheme. In examples, k different shares may be used in examples herein. At 934, the CTRL may calculate the MKB which in turn can be used to restore the local access database in volatile memory. At 940, the system may be functional (e.g., after restore/reboot).

A valid general database (e.g., 162) that may be accepted by one or more (e.g., all) CTRLs in the system, may be created (e.g., may only be created) by the system administrator. The system administrator may possess the administrator credentials to the CTRLs. The administrator credentials may not be possessed by a single CTRL, for example.

Examples described herein may allow full distribution of the system key management and databases among the controllers, for example, while not allowing limited numbers of CTRLs to have full access rights to master key material, if an administrator is not logged in to the system. The general database may not be available on a unit, for example, unless an authorized administrator is present or a full system reboot occurs.

In examples described herein, the system may not be dependent on the online presence of a central database for key management or for taking application system specific decisions. This may give higher robustness, for example, if there is a network loss to a central server.

In examples described herein, the system may be able to make full recovery at power loss/maintenance and/or reboot without being dependent on any central configurations or the presence of an authorized system administrator. This may give faster and/or robust recovery of the system, for example, after power loss or system/building/vehicle/vessel maintenance.

Strong confidentiality and/or integrity protection of the key material and/or application system data assets may be described herein, such that an attacker must compromise at least k number of CTRLs to break the basic security of the system. This may give the distributed system flexibility and a high security level. Examples described herein may share some characteristics with traditionally centralized systems, such as a single compromised administrator may allow the attacker to modify the general database.

Examples described herein may freely give failure robustness/back-up of security parameters as those may be distributed and may be shared among some or all devices within a domain. A single or limited number compromised CTRLs may be present at database update or system reboot and may leak the master key and/or other key material. A single or limited number of compromised CTRL may not be able to do any modifications to the database or other system assets, for example, depending on the domain keys, such as system logs. Further, in an example (e.g., when an administrator is not present in the system), an attacker, even if he/she compromises a limited number of CTRLs, may not be able to get access to the master key.

In examples herein, the basic security of the system may not depend on strong hardware/software CTRL platform security mechanisms. The basic security of the system may utilize the difficulty for an attacker to simultaneously compromise several CTRLs. This may provide an attractive security level for the system at a low cost.

Additionally, the system may work without general Internet connectivity or with general Internet connectivity. The system may be maintained through local administration on one or more (e.g., each) domain where an administrator connects to the system when (e.g., only when) the administrator may be present at the local domain. This may be useful for domains in remote locations and when the domain for security reasons may be protected from general Internet accesses.

In a distributed database example described herein, the use of group signatures may avoid the administrator clients' needs to sign the complete database when a database update occurs. With the use of group signatures, the administrator clients may be able to sign the delta between the old and new database, which may ease the administrator client implementation/processing and/or its security checks burden. The signing of delta database may makes it easier for the administrator client to update databased (e.g., no need to sign the complete new database but just the delta database). The use of group signatures may be different and may allow the CTRLs to reconstruct the complete database (e.g., new database) candidate using the signed delta value. this reconstructed database may be signed using individual keys from a group signature scheme by the CTRLs. When these signatures are pooled, they may give a valid group signature (e.g., new valid group signature) over the whole new dataset, for example, without involving the administrator further.

According to one or more examples, a distributed security feature, such as a loss or compromise of a limited number of CTRLs not compromising the basic security of the system, may be used described herein. For example, recovery at power loss may need communication availability between one or more local CTRLs for the system to be functional again. For robustness reasons, an implementation (e.g., similar communication pattern, etc.) without advanced security features may be difficult to distinguish from examples described herein. Such a system may be distinguished from examples described herein in that it may be easy to break the system by compromising a single unit.

To achieve a high level of security, examples herein may have more complex communication patterns at system recovery and may utilize more complex set-up and administration routines.

Secure distributed system key management, database setup and update may used in one or more examples as described herein. Examples herein may describe key management for database and log protection and/or database setup and update.

Application data may be handled using one or more datasets according to examples. For example, application data may be handed using the General Database (GD). The GD may comprise one or more (e.g., all) configurations and/or application system data for one or more (e.g., all) users and one or more (e.g., all) domains in the system. For example, application data may be handed using the Local Database (LD. The LD may comprise one or more (e.g., all) configurations and application system data utilized by the CTRLs in a single domain, such that the same or similar structure as the GD. The LD may comprise the information (e.g., only the information) utilized to handle the end system within this single domain.

Principles for managing the GD and generation of the LD together with aligned key management principles may be described and used in one or more examples. The principles may utilize a secret sharing scheme to protect the GD and LD. The device deployment/setup phase and the GD update phase may be described herein.

In an example, one or more (e.g., each) CTRL in the system may support functions. For example, one or more (e.g., each) unit may supports a secure battery backed-up clock that may not drift significantly from the true time. For example, one or more (e.g., each) unit may have a platform dependent secure integrity and/or confidentiality protection mechanism that may allow the CTRL to store in non-volatile memory integrity and/or the confidentiality protected dataset. The basic security of examples described herein may not be dependent protection being high.

Hardware methods for maintaining secure clock may be provided and/or used, but do not limit the examples disclosed herein. The NTP protocol or other secure clock technologies may to achieve secure clock values, but examples herein are not limited to these technologies. Hardware may exist to protect integrity and confidentiality of a dataset on a platform may exist, but do not limit the examples disclosed herein.

At system setup, one or more (e.g., each) CTRLᵢ within a domain, A, may not be given the key MK_{A} and may be given a public/secret share of MK_{A}. The share for unit i may be denoted by S_{Ai}. The shares may be generated using a secret sharing scheme, such that at least k-units in the domain may pool their shares to derive MK_{A}. S_{Ai} may be stored (e.g., permanently stored) in non-volatile memory in unit CTRLᵢ. When the GD may be about to be updated, the administrator may generate an authenticated update request to a chosen control node, such as CTRLⱼ in a domain. This request may be re-distributed by CTRLⱼ to at least k different CTRLs in a domain that checks the validity of the update request. If the validity of the update request is OK, the at least k different CTRLs in a domain may respond to the CTRLⱼ with their respective share, S_{Ai}. This may allow CTRLⱼ to obtain MK_{A}, reconstruct GD, and/or update GD. A secure update protocol may allow one or more (e.g., all) units in the domain to make the same update. After (e.g., directly after) an update of GD one or more (e.g., all) CTRLs in the domain may wipe out the key MK_{A} and/or the associated keys from memory.

A locally maintained GD may be disclosed herein. One or more (e.g., each) CTRL in the system may store in non-volatile memory the complete GD in encrypted and integrity protected form. When (e.g., only when) the system is configured and/or when the GD is updated by an authorized system administrator, the GD may exist in clear text in the CTRLs. The GD may be used to generate a LD that may be kept unchanged in non-volatile memory, for example, until a reboot or GD update occurs.

The system administrator may have access to a secret private key pair that may be used to securely update the GD when an access rule is to be updated. A central trusted authority for the system may maintain in secure storage a private public root key pair that may be used to create trust among the units in the system. One or more (e.g., each) authorized system administrator in the system may be given at least one private-public key pair and an administrator certificate that may contain a signature of the system administrator public key. This signature may be created using the private root key of the system. The system administrator may use this private-public key pair to set up secure sessions with CTRL units in the complete system and/or to sign arbitrary data. The system administrator may possess two public key pairs, for example, one for secure authentication and session establishment and/or one used for signing. For an administrator O, the private secret key pair may be denoted by {Pr_{O},Pk_{O}}. The administrator may be given a corresponding certificate certifying that it has administration rights for the key Pk_{O}. This certificate may be denoted by Cert_{adm}(Pk_{O}).

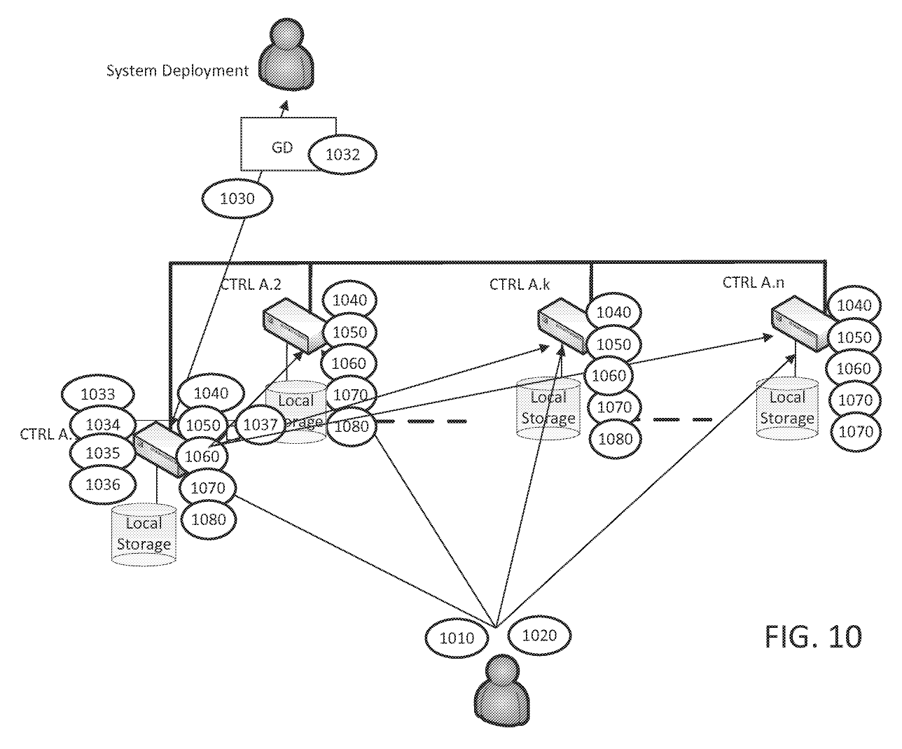

FIG. 10 illustrates an example device set up method for a distributed system (e.g., 100). At the first time the system may be configured, configuration may take place for one or more (e.g., each) domain in the system. The set of CTRLs in the domain may be denoted by A.

At 1010, a trusted system public root-key may be securely installed in one or more (e.g., each) CTRL unit in the domain. This key may be integrity protected, for example, using the platform dependent integrity protected dataset function.

At 1020, for one or more (e.g., each) iεA,|A|=n, a device specific private/public key pair may be generated and/or a corresponding certificate may be generated. The private key may be stored in the platform dependent confidentiality and integrity protected area on the device. The certificate may be signed, for example, using a private key that corresponds to the root key stored in 1010 or by a private key in a public-private key pair that may be verified by the public root key stored in 1010, for example, through a certificate chain. The key pair may be denoted by {Prᵢ,Pkᵢ}.

At 1030, a system administrator may use a computer client (e.g., suitable computer client) to connect through a secure channel, such as SSL/TLS/DTLS, to any CTRLᵢ in the domain. The channel may be mutual authenticated, for example, using the public-private keys of the administrator and/or the CTRLᵢ respectively. The administrator may request a secure system setup, for example, through a dedicated function provided by the CTRLᵢ. At 1031, the CTRLᵢ may check if it already has a configured shared secret in its platform confidentiality/integrity protected dataset. If the CTRLᵢ has a configured shared secret in its platform confidentiality/integrity protected dataset, the CTRLᵢ may abort the setup with an error. If the CTRLᵢ does not have a configured shared secret in its platform confidentiality/integrity protected dataset, the CTRLᵢ may go to 1032. At 1032, the administrator may create a new GD that may be used in the system (e.g., or the administrator may uses a copy of GD if this has already been configured in other domains for instance) and may send it to CTRLⱼ. At 1033, the CTRLᵢ may use a random function to generate a domain specific master key, MK_{A} and a random number N This number and a Pseudo Random Function (PRF) that takes MK_{A} and N as inputs may be used by the CTRLᵢ to generate one or more (e.g., two) keys material to protect the GD and other critical information assets, such as logs, etc. Among this key material, the GD encryption key may be generated. This key may be denoted by KE_{A}. At 1034, the CTRLᵢ may use a suitable threshold secret sharing scheme, S(k,n), for example, to divide the master key, MK_{A}, into n different secret shares: S_{A1}, S_{A2}, . . . , S_{An}. Examples described herein are limited to threshold secret sharing scheme and may be generalized such that they work with any secret sharing access structure. At 1035, the CTRLⱼ and/or the administrator may use a threshold group signature scheme, G(k,n), to generate a private-public key pair, {Pr_{A} Pk_{A}}, and n different private-public key share pairs: {Pr_{A1},Pk_{A1}}, {Pr_{A2},Pk_{A2}}, {Pr_{An},Pk_{An}}. Examples described herein are limited to threshold signature scheme and may be generalized such that they work with any group signature access structure. At 1036, the CTRLⱼ may sign the GD using the Pr_{A} to obtain sig_{A}(GD). At 1037, the CTRLⱼ may set up a secure channel with one or more (e.g., each) CTRLᵢ, ∀iεA, i≠j. The channel may be mutual authenticated using the keys {Prᵢ,Pkᵢ}, {Prⱼ,Pkⱼ}. Through this channel, CTRLⱼ may send to CTRLᵢ, the GD and the following parameters: MK_{A},N, Pk_{A}, S_{Ai}, {Pk_{Ai}, Pr_{Ai}}, sig_{A}(GD). 3a-3h may be performed by the administrator client computer.

At 1040, ∀iεA, CTRLᵢ, an LD may be derived, for example, based on the GD. The LD may be stored in volatile memory in the device and the key material generated from MK_{A} and N may be derived and stored in volatile memory.

At 1050, ∀iεA, the CTRLᵢ may store the following parameters in its platform confidentiality/integrity protected dataset: N, Pk_{A}, S_{Ai}, {Pr_{Ai},Pk_{Ai}}, sig_{A}(GD).

At 1060, the CTRLᵢ may sign GD using the private group key Pr_{A}.

At 1070, CTRLᵢ ∀iεA, CTRLᵢ may encrypt the GD with KE_{A} and may encrypt the LD using domain specific key material. The encrypted databases may be denoted by E(GD) and E(LD), respectively.

At 1080, one or more (e.g., each) CTRLᵢ may store E(GD) and E(LD) in non-volatile memory. One or more (e.g., each) CTRLᵢ in the domain may wipe out from memory at least the following data: GD, MK_{A}, KE_{A}. One or more (e.g., all) CTRLs in the domain set their current status to locked.

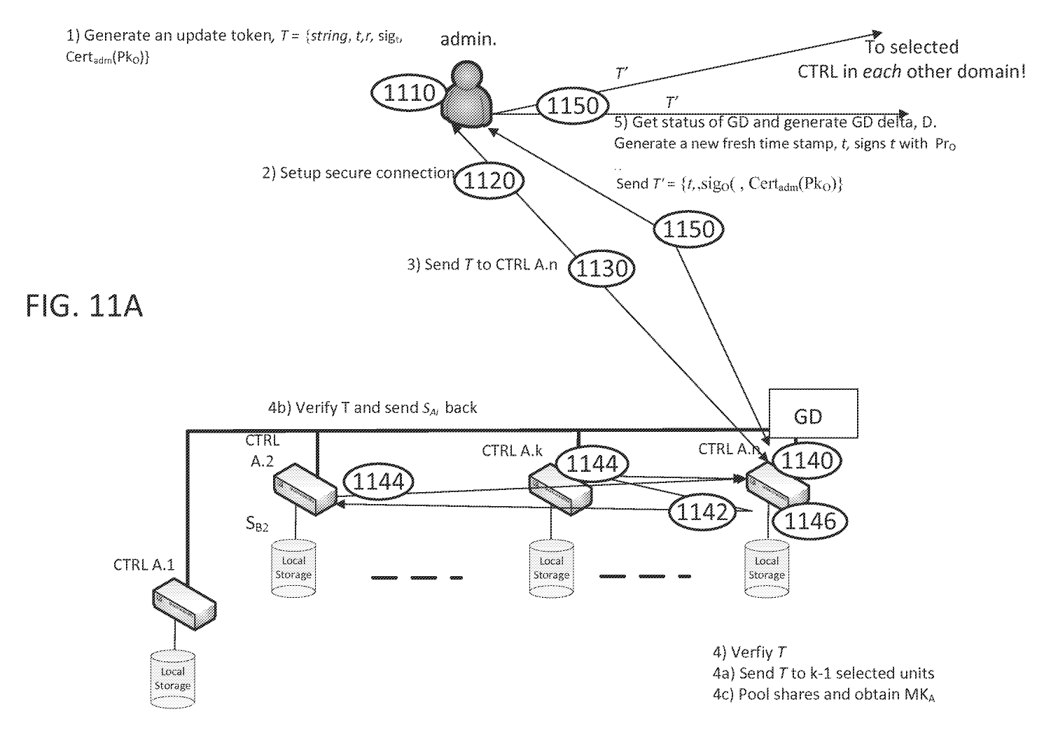

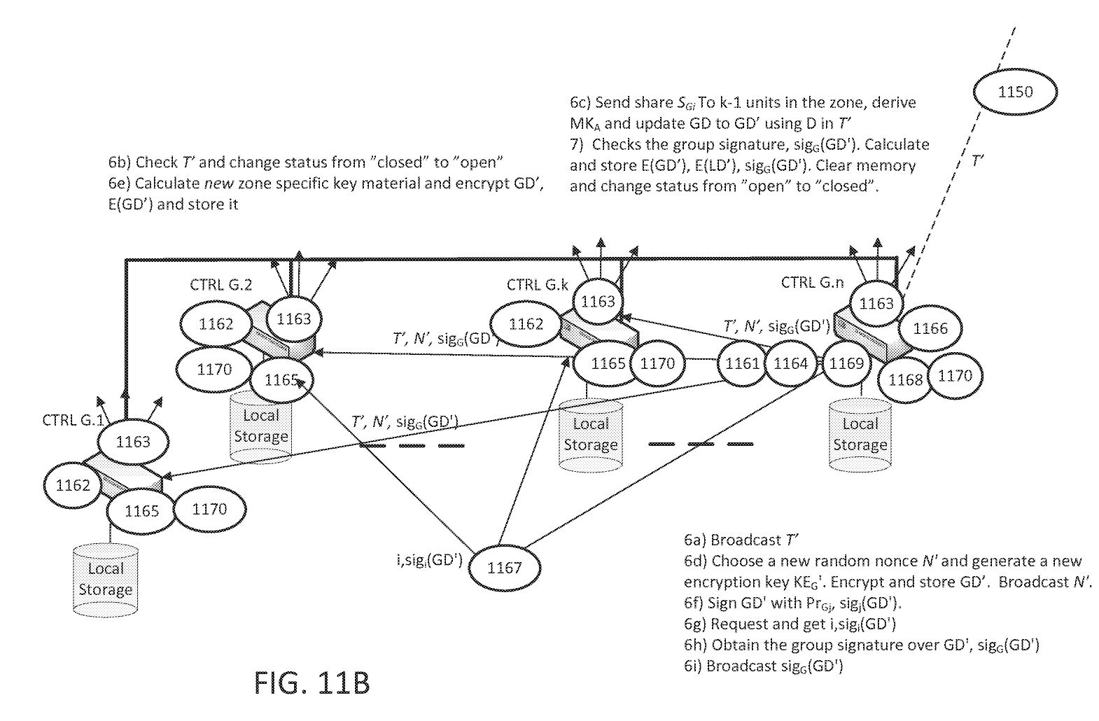

FIGS. 11A-11B illustrates a GD update procedure or method for a distributed system (e.g., 100). How the GD may be updated and how a corresponding LD may be created may be described herein.

At 1110, the administrator may generate a GD update token, T, that may be a signed data structure, for example, comprising the following information: a text string describing the token like GD update, a time stamp t, a random nonce r and/or a signature sigₜ over these parameters and the administrator certificate, Cert_{adm}(Pk_{O}), i.e., T={string, t,r, sigₜ, Cert_{adm}(Pk_{O})}.

At 1120, the administrator may contact a dedicated DTCRLⱼ in an arbitrary domain in the system, A, and a secure mutual authenticated channel may be create using the keys {Pr_{O},Pk_{O}} and {Prⱼ,Pkⱼ}.

At 1130, the administrator may send T to CTRLⱼ.

At 1140, the CTRLⱼ may verify that T is a fresh, timely token given its own secure clock and that the signature may be provided by an authorized administrator. If the check fails, the procedure is aborted. If the check is successful, the CTRLⱼ may proceed to 1142, 1144, and 1144. At 1142, the CTRLⱼ may send Tin a multicast message to k−1 selected CTRLs in Ω∪A. At 1144, ∀iεΩ, CTRLᵢ may verify that T is a fresh, timely token given its own secure clock and that the signature may be provided by an authorized administrator. If the check fails, the procedure is aborted. If the check is successful, CTRLᵢ may change its status from locked to open, and may send its share S_{Ai} back to CTRLᵢ over a mutual authenticated and protected channel. At 1146, CTRLⱼ may pool the received shares together. The CTRLⱼ may obtain MK_{A} and may use the stored nonce to derive the domain specific key material, including KE_{A}. The CTRLⱼ may use this key to decrypt E(GD).

At 1150, the administrator may exchange a set of messages with CTRLⱼ to get access to the current status of GD and identify a set of updates to be done to GD. One or more (e.g., all) identified changes may be collected into a delta dataset structure, Δ, by the administrator client. The administrator client may generate a new fresh time stamp, t, and signs t, Δ with the key Pr_{O} and may send a protected channel message T′={t,Δ,sig_{O}(t,Δ), Cert_{adm}(Pk_{O})} to CTRLⱼ and to one selected CTRL in one or more (e.g., all) the other domains in the system. This system-wide multicast may be done by the CTRLⱼ and not by the administrator client. When no general Internet connectivity is available, this may not be done and the administrator may physically visit one or more (e.g., each) domain in the system and perform the GD update procedure

At 1160, for one or more (e.g., each) domain, G, among one or more (e.g., all) domains in the system, 1161-1169 may takes place (e.g., CTRLⱼ may refer to the unit in the domain that received the delta message in 1150 from the administrator). At 1161, CTRLⱼ may contact one or more (e.g., all) units in G, ∀iεG, i≠j, and may send a protected channel and the message T′ to these units. This message may be sent using a protected broadcast. At 1162, ∀iεG, CTRLᵢ may check that T′ may be a true message from an authorized administrator and with a correct time stamp. If this check is successful, the CTRLᵢ may change its status from locked to open. For a given time period, the CTRLᵢ may accept a request for giving out its secret share S_{Gi} and be open to use its secret group signature key. At 1163, ∀iεG, CTRLᵢ may select k−1 CTRLs in a set Ω∪G and may send its secret share S_{Gi} over protected channels to these devices. This may allow one or more (e.g., each) CTRLᵢ to pool one or more (e.g., all) k shares together to calculate MK_{G} and use this and the stored value N to calculate KE_{G}. The one or more (e.g., each) CTRLᵢ may derive the clear text of GD and update it according to Δ. A new LD may be calculated, LD′, for example, based on the updated GD, GD′. The one or more (e.g., each) CTRLᵢ may store the new LD′ in volatile memory in the device. At 1164, the CTRLⱼ may choose a random nonce N′ and may generate an encryption key KE_{G}′. KE_{G}′ may be used to encrypt the new GD′ and to store E(GD′) in non-volatile memory. N′ may be broadcasted to one or more (e.g., all) CTRLs, ∀iεG, i≠j. At 1165, ∀iεG, i≠j, CTRLᵢ may use the retrieved MK_{G} to calculate domain specific key material. A GD′ encryption key i may be derived, KE_{G}′. This key may be used to encrypt GD′, E(GD′), which may be stored on non-volatile memory on the device. At 1166, CTRLⱼ may sign the GD′ with its private group key Pr_{Gj}, sigⱼ(GD′). At 1167, CTRLⱼ may select k−1 suitable CTRLs in G. This subset may be denoted by Ω, i.e. |Ω|=k−1. ∀iεΩ. At 1168, CTRLⱼ may send a secure channel to a request for the signature of GD′. At 1169, CTRLᵢ may send in return to CTRLⱼ the tuple i,sigᵢ(GD′). A proof of the signature may be valid may also be utilized. The CTRLⱼ may pool its own signature sigⱼ(GD) and one or more (e.g., all) the received signatures, ∀iεΩ, i,sigᵢ(GD′) to obtain the group signature over GD′, sig_{G}(GD′). The CTRLⱼ may broadcast sigᵢ G(GD′) to one or more (e.g., all) DTCRLᵢ, ∀iεG, i≠j.

At 1170, for one or more (e.g., each) domain G in the system and ∀iεG, CTRLᵢ may check the group signature, sig_{G}(GD′). If the sig_{G}(GD′) is valid against the local GD′ and not the new GD′, the old GD may still be in use The domain G may store the signature in its platform confidentiality/integrity protected dataset. A new LD′ may be calculated and may be stored (E(LD′)) in non-volatile memory protected using the domain specific key material. One or more (e.g., each) CTRLᵢ stored E(GD′) in non-volatile memory and one or more (e.g., each) CTRL in the domain may wipe out from memory at least the following data: GD, GD′, MK_{G}, KE_{G}′. One or more (e.g., each) CTRLᵢ may change its status from open to closed. A recovery procedure may apply as the CTRLs may not have a common view of the GD and may be resynchronized.

This may ensure that at least k different CTRLs agree on the new domain specific key material and the updated GD′, for example if the data may be accepted and an attacker only has the choice to either compromise the system administrator client computer or to compromise at least k CTRL units in the system in order to create a false domain key material or a GD update.

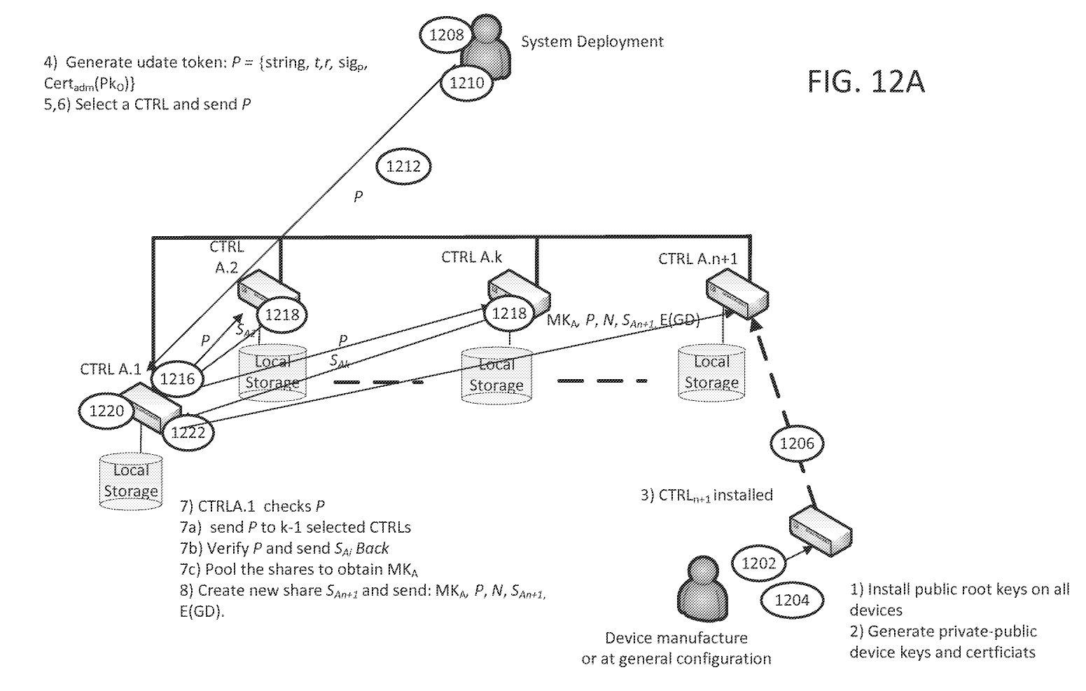

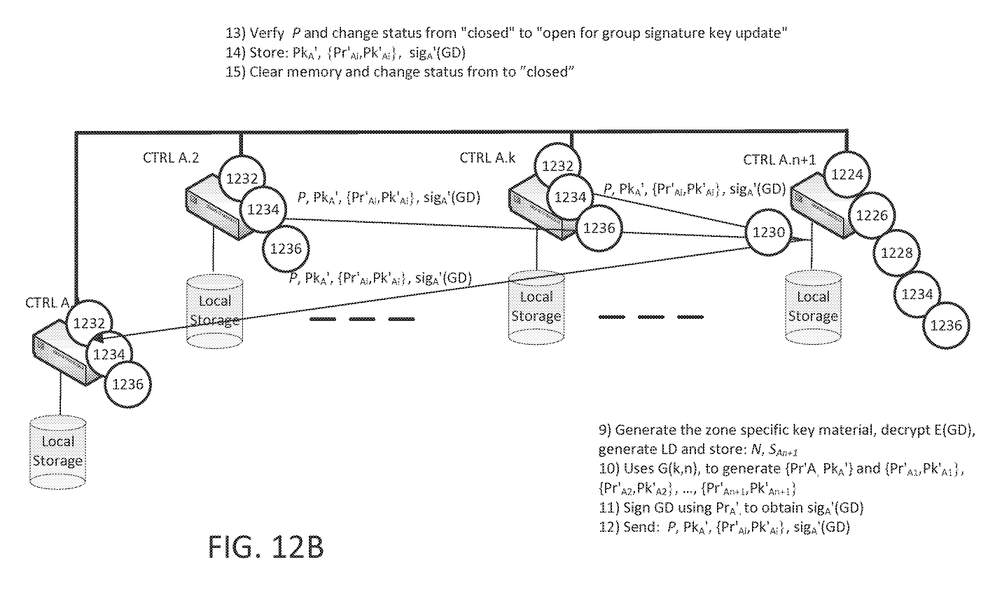

A CTRL (e.g., a new CTRL) may be added to an existing domain in examples herein. FIGS. 12A-12B illustrate an example method of adding a unit to an existing installation. For example, an administrator may add a CTRL to an existing domain. As shown, at 1202, by an authorized system administrator or at a factory, a trusted system public root-key may be securely installed in a CTRL (e.g., a new CTRL) to be installed in the domain. This key may be integrity protected, for example, using the platform dependent integrity protected dataset function.

At 1204, for the CTRLₙ₊₁, a device specific private/public key pair may be generated and a corresponding certificate may be generated. The private key may be stored in the platform dependent confidentiality and integrity protected area on the device. The certificate may be signed using a private key that corresponds to the root key installed at 1202 or by a private key in a public-private key pair that, through a certificate chain, may be verified by the public root key. The key pair may be denoted by {Prₙ₊₁,Pkₙ₊₁}.

At 1206, the CTRLₙ₊₁ may be installed in the distributed system and connected to the local IP network.

At 1208, the responsible system administrator may generate an update token, P. The update token, P, may be a signed data structure comprising the following information: a text string describing the token-like system update, a time stamp t, a random nonce r and/or a signature sigₚ over these parameters, and the administrator certificate, Cert_{adm}(Pk_{O}), where P={string, t,r, sigₚ, Cert_{adm}(Pk_{O})}.

At 1210, the administrator may contact a selected CTRLⱼ in the domain where, for example, where the CTRLₙ₊₁ may have been installed and a secure mutual authenticated channel may have been created using the keys {Pr_{O},Pk_{O}} and {Prⱼ,Pkⱼ}. This message may be sent by the administrator. This message may not be sent from the administrator. This message may be sent by a request from the administrator from the DCTRLₙ₊₁.

At 1212, the administrator may send P to CTRLⱼ.

At 1214, the CTRLⱼ may verify that P is a fresh, timely token, for example, given its own secure clock and that the signature may be provided by an authorized administrator. In an additional example, at 1214, the CTRLᵢ may verify that P is a fresh, timely token, for example, given its own secure clock and that the signature may be provided by an authorized administrator. If the check fails, the procedure may be aborted. If the check is successful, the CTRLⱼ may proceed to 1216, 1218 and 1220. In an additional example, if the check is successful, the CTRLᵢ may proceed to 1216, 1218 and 1220. The CTRLⱼ may send P in a multicast message to k−1 selected CTRLs in Ω∪A. In an additional example, the CTRLᵢ may send P in a multicast message to k−1 selected CTRLs in Ω∪A. At 1218, ∀iεΩ, CTRLⱼ may verify that P is a fresh, timely token given its own secure clock and that the signature may be provided by an authorized administrator. In an additional example, at 1218, ∀iεΩ, CTRLᵢ may verify that P is a fresh, timely token given its own secure clock and that the signature may be provided by an authorized administrator. If the check fails, the procedure is aborted. If the check is successful, the CTRLᵢ may change its status from closed to open and it may send its share S_{Ai} to CTRLⱼ over a mutually authenticated and protected channel. In an additional example, if the check is successful, the CTRLᵢ may change its status from closed to open and it may send its share S_{Ai} to CTRLⱼ over a mutually authenticated and protected channel. At 1220, CTRLⱼ may pool the received shares together and may obtain MK_{A}. In an additional example, at 1220, CTRLᵢ may pool the received shares together and may obtain MK_{A}.

At 1222, by request of the administrator, the CTRLⱼ may create a new share of MK_{A}, S_{An+1} and may set up a secure (e.g., mutually authenticated channel) towards CTRLₙ₊₁. The CTRLⱼ may send the following information: MK_{A}, P, N, S_{An+1}, E(GD) to CTRLⱼ.

At 1224, CTRLₙ₊₁ may verify that P changed status from closed to open. The CTRLₙ₊₁ may accept MK_{A} and may use the MK_{A} and N to generate the domain specific key material. The CTRLₙ₊₁ may obtain the encryption key KE_{A} and may decrypt the E(GD) that may be used to generates an LD that may be stored in internally volatile memory together with other needed domain specific key material. The CTRLₙ₊₁ may store the parameters N, S_{An+1} in its platform confidentiality/integrity protected dataset.

At 1226, the CTRLₙ₊₁ may use a suitable threshold group signature scheme, G(k,n), to generate a new private-public key pair, {Pr′A, Pk_{A}′}, and n+1 private-public key share pairs: {Pr′_{A1},Pk′_{A1}}, {Pr′_{A2},Pk′_{A2}}, . . . , {Pr′_{An+1},Pk′_{An+1}}.

At 1228, the CTRLₙ₊₁ may sign the GD using the Pr_{A}′ to obtain sig_{A}′(GD).

At 1230, the CTRLₙ₊₁ may set up a secure channel with one or more (e.g., each) CTRLᵢ, ∀iεA, i≠j. The channel may be mutually authenticated using the keys {Prᵢ,Pkᵢ}, {Prⱼ,Pkⱼ}. Through this channel, the CTRLₙ₊₁ may send to CTRLᵢ, the parameters P, Pk_{A}′, {Pr′_{Ai},Pk′_{Ai}}, sig_{A}′(GD).

At 1232, CTRLᵢ ∀iεA−Ω, i≠n+1, may verify the received parameter P and the signature, sig_{A}′(GD). If the verification is OK, CTRLᵢ may change its status from closed to open for group signature key update.

At 1234, CTRLᵢ ∀iεA, may store the following parameters in its platform confidentiality/integrity protected dataset: Pk_{A}′, {Pr′_{Ai},Pk′_{Ai}}, sig_{A}′(GD).

At 1236, one or more (e.g., each) CTRL in the domain may wipe out from memory at least the following data: GD, MK_{A}, KE_{A}′. One or more (e.g., each) CTRL in the domain may change its status from open or open for group signature key update to closed.

Examples described herein may be applicable to a centrally stored GD. Further, examples described herein may be based on public keys and similar to examples described with respect to locally stored GDs. Examples described with respect to a centrally stored GD may be utilized in the automotive and ship applications (e.g., shown in FIGS. 5-6).

One or more (e.g., each) authorized system administrator in the system may be given at least one private-public key pair and an administrator certificate that comprises a signature of the system administrator public key, by {Pr_{O},Pk_{O}}, Cert_{adm}(Pk_{O}). In examples described herein, the system administrator may possess one or more (e.g., two) public key pairs, for example, one public key for secure authentication and session establishment and one public key used for signing.

For centrally stored GDs, no group signature scheme may be used. For centrally stored GDs, administrator may sign (e.g., may always sign) the GD.

In a centrally stored GD, the system setup may be similar to the system setup for locally maintained GDs. For example, for the centrally stored GD, 1010, 1020 may be the same as for the locally stored GD. At 1030, a system administrator may use a suitable computer client to connect through a secure channel, such as SSL/TLS to any suitable CTRLᵢ. The channel may be mutual authenticated using the public-private keys of the administrator and the CTRLᵢ respectively. The administrator may request a secure system setup through a dedicated function, for example, provided by the CTRLᵢ. For the centrally stored GD, 1031, 1033 and 1034 may be the same as for the locally maintained GD. For the centrally stored GD, 1035 for the locally stored GD may be removed. At 1032, the administrator may create a new GD to be used in the system and store this in suitable central database. The GD may be securely transferred to CTRLᵢ. At 1036, the administrator may sign the GD, for example, using the Pr_{O} to obtain sig_{O} (GD) and may send this signature together with Cert_{adm}(Pk_{O}) to the CTRLᵢ At 1037, the CTRLⱼ may set up a secure channel with one or more (e.g., each) CTRLᵢ, ∀iεA, i≠j. The channel may be mutually authenticated using the keys {Prᵢ,Pkᵢ}, {Prⱼ,Pkⱼ}. Through this channel CTRLⱼ may send to CTRLᵢ, the GD and the following parameters: MK_{A},N,Cert_{adm}(Pk_{O}), KE_{A}, S_{Ai}, sig_{O}(GD).

For the centrally stored GD, 1040 is the same as for the locally maintained GD. At 1050, for the centrally stored GB, the CTRLᵢ ∀iεA, may store the following parameters in its platform confidentiality/integrity protected dataset: N, Cert_{adm}(Pk_{O}), S_{Ai}, sig_{O}(GD). For the centrally stored GD, 1060 and 1070 are the same as for the locally maintained GD.

The GD update for centrally stored GDs may be described herein. For the GD update for centrally stored GDs, the administrator may contact the central database, obtain the GD, and/or identify the GD updates to be conducted. The delta between the old and new GD, GBD′ may be calculated A. The administrator may sign the new GD′, sig_{O}(GBD′). The administrator may generate a GD update token, T, that may be a signed data structure comprising the following information: a text string that may describe the token-like GD update, a time stamp t, a random nonce r and/or a signature sigₜ over these parameters, and the signature over GBD′, the A and the administrator certificate, Cert_{adm}(Pk_{O}), i.e., T={string, t, r sigₜ, sig_{O}(GD′), Δ, Cert_{adm}(Pk_{O})}. The administrator may send the message T to one selected CTRL on a protected channel in one or more (e.g., all) domains in the system.

For the GD update for centrally stored GDs, for one or more (e.g., each) domain, G, among one or more (e.g., all) domains in the system, the following may occur (e.g., CTRLⱼ refers to the unit in the domain that received the delta message as described above from the administrator). The CTRLⱼ may contact one or more (e.g., all) units in G, ∀iεG, i≠j, and may send over a protected channel a message containing T. The message may be sent using a protected broadcast. ∀iεG, CTRLᵢ may check that T may be a true message from an authorized administrator and that T has a correct time stamp. If this check is successful, the CTRLᵢ may change its status from locked to open. The CTRLᵢ may, for a given time period, accept request for distributing its secret share S_{Gi}. ∀iεG, CTRLᵢ may select k−1 CTRLs in a set Ω∪A and may send its secret share S_{Gi} over protected channels to these devices. This may allow one or more (e.g., each) CTRLᵢ to pool one or more (e.g., all) k shares together to calculate MK_{G} and use this and the stored value N to calculate KE_{G} and derive the clear text of GD and update it according to Δ. The hash of the updated GD may be checked against the received signature in T. If this check is OK, an LD may be calculated, LD′, based on the updated GD. This allows one or more (e.g., all) CTRLs to store the LD′ in volatile memory in the device. CTRLⱼ may chose a random (e.g., new random) nonce N′ and generate an encryption key KE_{G}′. KE_{G}′ may be used to encrypt the GD′, E(GD′), which may be stored on non-volatile memory on the device, and an encrypted version (E(LD′)), for example, using the domain specific key material derived from N′. N′ may be broadcasted to one or more (e.g., all) CTRLs, ∀iεG, i≠j. ∀iεG, i≠j, CTRLᵢ may use the retrieved MK_{G} to calculate domain specific key material. The CTRLᵢ may generate a KE_{G}′ and this key may be used to encrypt GD′, E(GD′), which may be stored on non-volatile memory on the device.

For the GD update for centrally stored GDs, for one or more (e.g., each) domain G in the system and ∀iεG, CTRLᵢ may store the signature sig_{O}(GD′) with Cert_{adm}(Pk_{O}) in its platform confidentiality/integrity protected dataset. One or more (e.g., each) CTRL in the domain may wipes out from memory at least the following data: GD, GD′, MK_{A}, KE_{A}′. One or more (e.g., each) CTRLᵢ may change its status from open to closed.

The suggested procedure for the GD update for centrally stored GDs may ensure that at least k different CTRLs agree on the GD′ update request if the request should be accepted and the GD updated. An attacker only has the choice to compromise the system administrator client computer to request a valid GD update. At least k CTRL units must be compromised if the attack should be able to unlock the GD in the system if the administrator not indeed is present.

As described with respect to a locally stored GD, a CTRL (e.g., a new CTRL) may be added to an existing domain in a centrally stored GD. For example, for a centrally stored GD, a CTRL may be added to an existing domain by 1202-1236, expect that in 1222, the CTRLⱼ may send the following information: sig_{O}(GD′), Cert_{adm}(Pk_{O}) and that these parameters may be stored by CTRLₙ₊₁ in 1224. For a centrally stored GD, 1226-1234 may be omitted when adding a CTRL to an existing domain.

System recovery at power loss/reboot may be described herein and/or implemented in one or more examples. Local database (LD) recovery on a single domain at power loss may be described herein. LD recovery on a single domain at power loss may allow a reasonable level of security without costly (e.g., from manufacture and maintenance points of view) battery back-up (e.g., except for low power battery back-up) on the CTRLs. Examples described herein may allow one or more (e.g., all) CTRLs within a single domain to recover some or all information utilized to make physical access control decisions without contacting a central database unit (e.g., see FIG. 9)

For LD recovery on a single domain at power loss, a domain A may lose its power and one or more (e.g., all) CTRLs may lose their power for longer or shorter periods. After a while, the power may come back, ∀iεA CTRLᵢ may be rebooted and may change its status from locked to open due to recovery. A domain A may lose its power due to general power loss or due to building maintenance reasons for instance.

For LD recovery on a single domain at power loss, when ∀iεA, the CTRLᵢ may send a multicast message to k−1 selected CTRLs in Ω∪A. ∀jεΩ, the CTRLⱼ may send its share S_{Ai} back to CTRLj, for example, over a mutual authenticated and protected channel. The CTRLᵢ may pool the received shares together and may obtain MK_{A} and may use the stored nonce to derive the domain specific key material. The CTRLᵢ may use the KE_{A} to decrypt the GD and derive LD which may be stored in volatile memory. The CTRLᵢ may use the key material to directly decrypt a local encrypted copy of LD and may store it in volatile memory. The CTRLᵢ may change its status from open due to recovery to locked. This may not happen immediately. This may happen after a certain period of time allowing one or more (e.g., all) units in the domain to cover before the system is locked. The system may be fully functional.

Syslog standards may be described herein and used in examples. The IETF syslog standard may be a protocol for generation and transfer of log information, such that log information may be stored and managed at a different location from where it is generated (e.g., a common setting from many distributed systems). The syslog standard may include specification of log message structure and log data structures. The syslog base standard may not contain advanced security mechanisms or principles for more robust log message handling. Secure syslog transfer over TLS and UDP may comprise mapping the syslog protocol into the standard TLS and DTLS giving confidentiality and integrity protection during syslog message transportation.

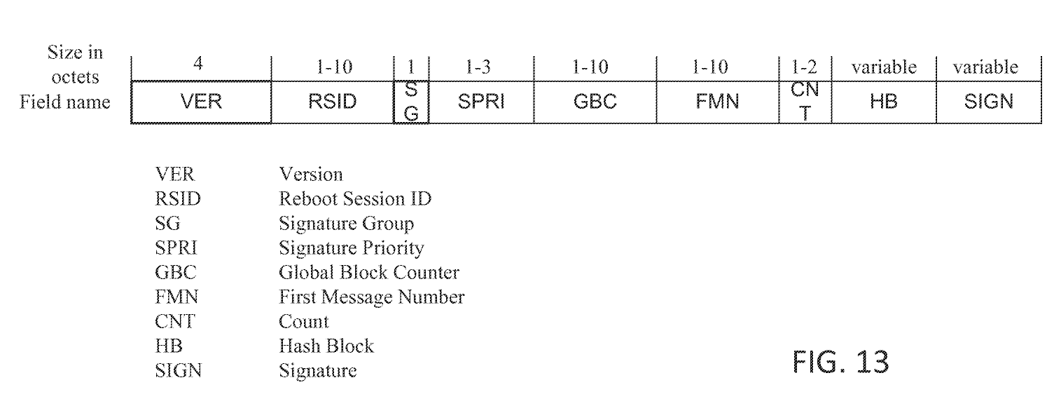

FIG. 13 illustrates an example syslog signature block format. Protection and transport of log message and the possibility of secure log origin verification may be utilized for syslog message signing handling. The syslog signature format may be compliant with the syslog message protocol and data format. The signature block format may have the structure depicted in FIG. 13.

The fields VER and CNT may be used for log sequence tracing and grouping. The Hash Block (HB) may be the main security principle in the syslog signing scheme. The Hash Block (HB) may comprise a block of hashes representing the sequence of syslog messages that the signature block may protect. The maximal number of hash blocks that may be included in the hash block may be limited by the overall signature block message size limit that may be set to 2048 octets. The signature field (SIGN) may comprise a digital signature, such as a digital signature that is public key based. The digital signature may be over one or more (e.g., all) message fields in the syslog signature message, except the SIGN field. The syslog standards may allow for several different digital signature schemes and public key verification principles, such as using certificates.

The IETF standard may define reliable syslog and may comprise simple MD5 digest mechanism for integrity protection.

Forward secure stream integrity schemes or methods may be described herein and implemented (e.g., in the system 100). A compromised log generation node used to modify or add entries to previously logs produced by the same entity after that the node compromised occurred may be prevented. This may be referred to as forward secure integrity.

A unit, U, in the system may produces log data entries. According to some embodiment, the node U may establish a shared secret key A₀ with a trusted remote server T. A sequence of log data entries produced by U may be denoted by M₀, M₁, . . . , Mₙ. One or more (e.g., each) log data entry may be transformed to a protected log entry. The sequence of such log entries may be denoted by L₀, L₁, . . . , Lₙ, where

Lᵢ={Wᵢ,E_{K}_{ᵢ}(Mᵢ₎),Yᵢ,Zᵢ},

Wᵢ may be an authorization mask that may determine which entities that get access to the clear text of the log data entry Mᵢ. E_{K}_{ᵢ}(Mᵢ) may denote encryption of the entry Mᵢ, for example, with the key Kᵢ. Yᵢ may be a hash chain value calculated as:

Yᵢ=H(Yᵢ₋₁,E_{K}_{ᵢ}(Mᵢ₎),Wᵢ),Y₀=H(M₀),

where H may denote a secure one-way hash function. Zᵢ may be a Message Authentication Code (MAC) that may be calculated as:

Zᵢ=MAC_{A}_{ᵢ}(Yᵢ).

The key material may be calculated as a chain of has values as follows:

Aᵢ₊₁=H(“Incremental hash”,Aᵢ),

Kᵢ=H(“Encryption Key”,Wᵢ,Aᵢ).

The log entry production may allow a verifier, V, to read a particular sequence of log entries, for example, at any time and by requesting U to check a series of corresponding MAC values and verify the correctness of the produced log series. After the generation of a certain amount of log entries, say 0, 1 . . . , i, even if the node U get compromised, it may not be able to modify or produce false log entries with index 0.1, . . . , i−1 as it may not have access to the values A₀, A₁, . . . , Aᵢ₋₁. The node U may remove this secret value in the key chain from memory when the secret values have been used. By chaining the log data entries, an adversary may not be able to remove entries from a valid log sequence because removing the entries may corrupt log entry hash chain.

A more advanced threat model may consider or provide attacks against stored log entries. A trusted regulatory entity may be introduced into the system model, for example, to protect the log entries and to send log entry public key signatures to this trusted entity. This may produce a more complex scheme with little added security. Instead of introducing a new entity, to give higher robustness in log entry storage protection, multiple entities may hold the log entries that make it more difficult to destroy log evidence in practice for an attacker.

A modified forward secure stream protection may replace a MAC by a public key signature using identity based encryption. This may simplify the verification of log entries to the prize of higher computational secure log entry generation costs. Hash chains may be utilized to link different log entries together.

The message logs that not yet have been delivered to T may be truncated without detection. This may be prevented by delivering logs as fast as possible to the trusted receiver, T. The log entries may be more compact by utilizing forward-secure aggregate authentication. Instead of calculating a chain of hashes on the different log message together with individual MACs on one or more (e.g., each) log entry, a chain of hashes of the log messages and the individual MAC values may be utilized. The integrity check value, IVᵢ for log entry i may be calculated as:

IVᵢ=H(IVᵢ₋₁,MAC_{A}_{ᵢ}(Mᵢ)).

Key updates may be conducted using examples described herein. For example, erasing the keys and the previous individual MAC values from memory when the new IV has been calculated may prevent the truncation attack and may reduce the amount of memory/bandwidth used to store and send protected log entries as a single combined integrity check and message chain value utilized in storing or sending.

A secure log architecture may comprise a secure log collection. An entity, such as a BBox may be utilized. The BBox may be utilized to verify log entries and/or generate public key signatures that may be used by log producers to sign log entries. The log entries may be protected with a hash chain principle. Trusted computing techniques may allow an external verifier to attest the state of the BBox entity.

A system for log protection using a proxy model may be described herein. The log generation may not provide integrity protection of log records. A proxy unit may provide integrity protection of log records. The integrity protection mechanism may comprise ordinary digital signatures.

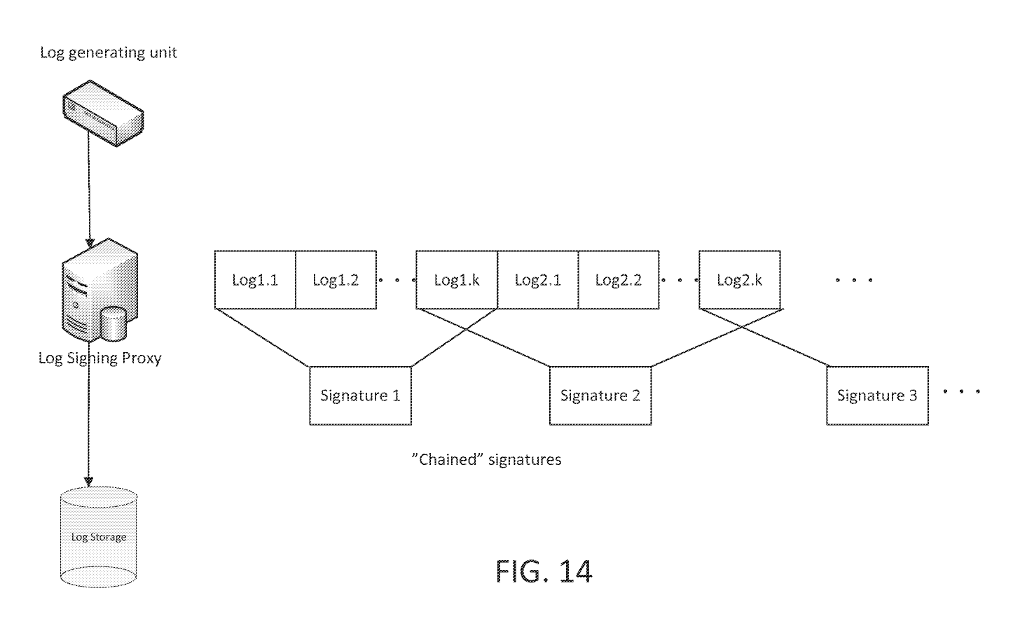

FIG. 14 illustrates an example log protection architecture or scheme that may be used in the system (e.g., 100). A example for a Physical Access Control System (PACS) (e.g., as described herein, for example, above) may comprise access control and secure logging of accesses work without requiring continuous online connection to a central connectivity. The system may be independent of doors and lock controllers of the physical access control system and may have connection to a central system. User devices, such as the devices used by the end-users that request physical access, may carry up to date credential and revocation information. This may apply to logging information that may be digitally signed (e.g., by controller) and transferred to a smart card of a user device for future verification. The main threat against physical access control logs, such as a hostile insider that removes or destroys physical access control logs, may be treated by the system as the end-user potentially carrying the log evidence so that the hostile inside may destroy the log evidence.

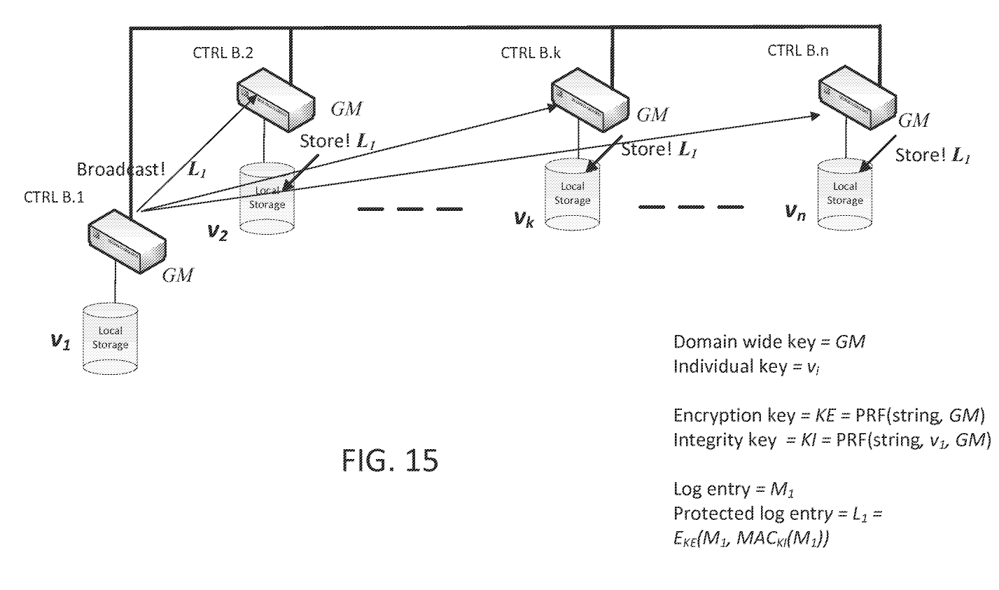

FIG. 15 illustrates an example of distributed system or part of the distributed system 100 that may implement log protection. To handle robustness and security requirements, a flexible system for log information protection that does not rely on online connection to a central repository or on a single local storage at a CTRL may be described herein. Examples may described herein in which one or more (e.g., each) CTRL within a single distributed domain stores new log information in its own local storage and uses protected (e.g., confidentiality and integrity protected) broadcast of this information to one or more (e.g., all) other CTRLs within the domain. One or more (e.g., each) other unit (e.g., after secure verification of the broadcasted log) within the domain may store the same log information in their local storage. The loss of a single log entry or several log entries in a single or a limited number of units may not create a risk that security critical log information will be lost. A robust and secure principle for deriving the keys may be utilized to protect this broadcasted information may be available. Keys, such as group master secretes, GM, may be distributed among the CTRLs within a domain. The group master keys may be used to generate domain wide confidentiality and integrity protection keys. The group master secrets may be shared among the CTRLs, for example, using a secret sharing scheme. This may allow strong protection of the group master keys without the need for special key protection hardware. The domain wide key may be kept (e.g., may always be kept) in volatile memory, for example, such that it may be difficult for an attacker with physical access to the device to get ahold of this key. The group master keys may be used to derive domain wide shared keys for some or all units within a domain to protect the broadcasted log messages. The group master keys may be used with a CTRL individual integrity protection key (e.g., a secret index) to protect individual log entries from one or more (e.g., all) the CTRLs. Individual key for a particular unit i in a domain may be denoted by vᵢ. This key may be stored (e.g., may only be stored) in non-volatile memory and updated using a hash chain. The keys that are used for integrity protect individual logs may not (e.g., may never) be stored in potentially vulnerable local persistent storage. The keys that are used for integrity protect individual logs may be stored on volatile memory on the devices. The secret sharing based examples described herein may allow fast recovery of both the domain wide and the individual keys locally within a domain, for example, at power loss or system maintenance. Examples described herein may describe how to securely collect and verify the distributed log information within a domain and move it into a well-protected central repository where it may be used for future processing or used to free storage resources on the CTRLs in the different domains. Securely generating log protection keys and as protecting the actual log information in the domains may comprise log protection key distribution and configuration, secure log generation and distributed storage and key update procedure, protected log collection, verification and memory clean up, and/or log protection key recovery at system power loss or reboot.

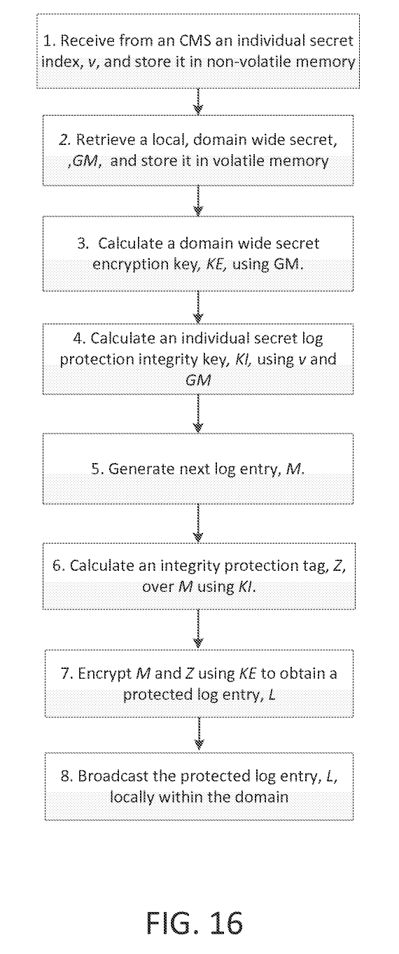

FIG. 16 is an example flowchart for distributed system log protection. At 1, a CTRL in a domain may receive from a CMS an individual secret index, v, and store it in non-volatile memory. The CTRL may retrieve a local, domain-wide secret, GM, and store it in volatile memory at 2. The CTRL, at 3, may calculate a domain-wide secret encryption key, KE, for example, using GM. In an example, at 4, the CTRL may calculate an individual secret log protection integrity key, KI, for example, using v and GM. The CTRL may generate a next log entry, M at 5 and, at 6, the device (e.g., CTRL) may calculate an integrity protection tag, Z, over M using KI. At 7, the CTRL may encrypt M and Z using KE to obtain a protected log entry, L. Further, at 8, the CTRL may broadcast the protected log entry, L, locally within the domain.

Examples described herein may provide a secure robust log protection scheme or method in distributed systems (e.g., 100). The individual log integrity protection key derivation may utilize a secret sharing scheme in combination with individual keys on one or more (e.g., each) device. Through this combination, an attacker able to compromise a single CTRL may not be able to compromise the log security of any other device in the local domain/network (e.g., as long as not those devices are compromised). By combining this key generation with the key update described herein, a single compromised CTRL may only allow an attacker to modify log entries at the time of compromise or later and not generate or modify already generated entries.

By using protected broadcasting and multiple storage of log entries on one or more (e.g., all) devices within a domain, loss of generated (e.g., protected) log entries may be prevented. This may prevent, for example, the following attack on a PACS system. For example, in a system where special CTRLs may be used to control the access to the entrances of a building or factory area, an insider, such as an employee of a company or the like, may gets access to this building or area and perform illegal actions. The insider attacker may have the legal right to enter at a door and may enter a protected area and steal the CTRL (e.g., including local storage) giving him/her the access. In such an example, this may not allow the attacker to be able to destroy or remove from the system the access log for the entrance event as this information may be securely stored on one or more (e.g., all) other CTRLs in the domain (e.g., and it may be impractical for the insider to steal and find some or all CTRL within the domain). Examples described herein may efficiently prevent insider attackers from destroying essential log events that can be used for evidence for act of crime.

Examples described herein may allow a central unit to securely collect and/or verify distributed log information within a domain and/or free local storage resources on potentially resource limited CTRLs within the domain. The log collection and log verification examples may be aligned with the key generation examples, for example, giving an overall secure and robust principle for log collection and verification.

The examples described herein may be able to make full recovery of log protection keys at power loss/maintenance and/or reboot without being dependent on central configurations or the presence of an authorized system administrator. This may provide for fast recovery of the system after power loss or system maintenance, while avoiding the master key being stored on any of the CTRLs in persistent storage. Expensive special purpose hardware for key protection may be avoided.

Examples described herein may be independent of, but may be applied together with, the syslog standard format.

Protection log generation and storage may be described herein. A system may exist, such as the system described with respect to FIG. 1, in which a set of distributed CTRLs generates security sensitive log information. In order to protect this log information, a system administrator at domain deployment may configure one or more (e.g., all) CTRLs within a certain domain with some key material. When the key material is in place, the CTRLs within the domain may be able to securely generate and store system logs. Examples described herein may comprise system deployment and/or log generation.

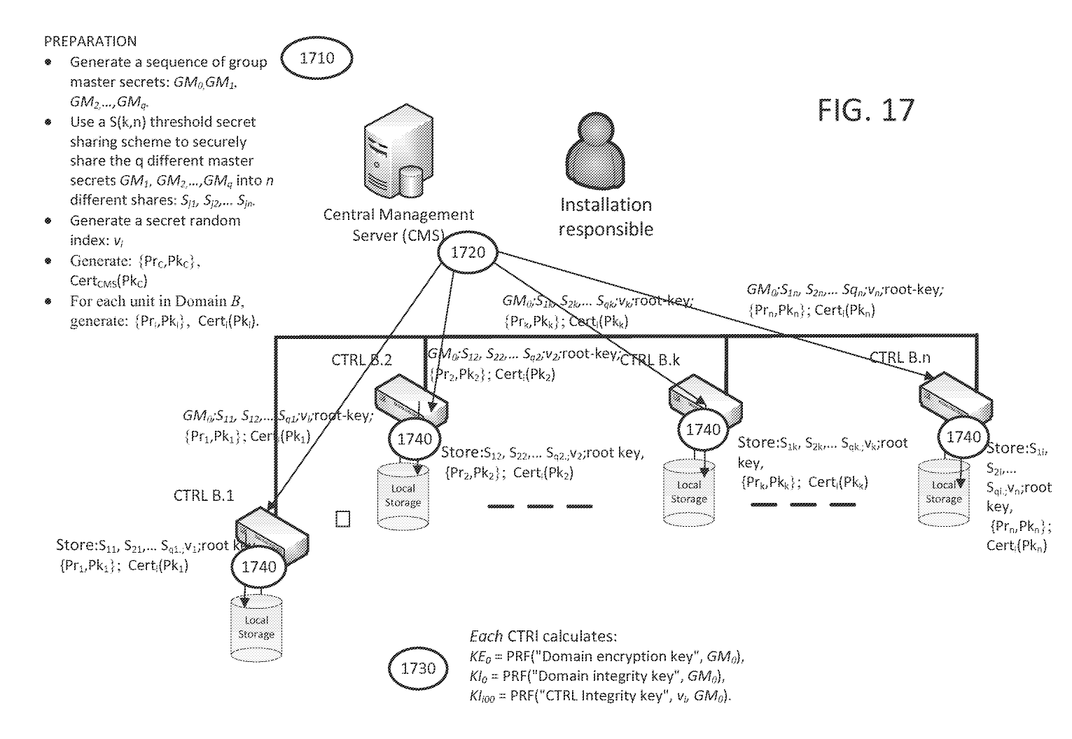

FIG. 17 illustrate an example system deployment for distributed system log protection method or scheme that may be provided as described herein.

At 1710, the CMS may be configured with a secret private key pair that may be used to securely communicate with one or more (e.g., all) of the CTRLs in the system. The CMS may be configured to comprise at least one private-public key pair and a corresponding certificate. The private secret key pair may be denoted by {Pr_{C},Pk_{C}} and the certificate may be denoted by Cert_{CMS}(Pk_{C}). The certificate may be able to be signed by a system-wide private key or by a private root-key of the system.

At 1710, at system deployment, a central administrator, through the CMS or through direct communication, may have be able to securely (e.g., over an authenticated, integrity and confidentiality protected channel, local or remotely), communicate with one or more (e.g., each) individual CTRL in a particular domain, B, in the distributed system. Before the domain may be deployed, the system administrator may request a management client or the CMS performing the following functions. The CMS may use a good random sources to generate a sequence of group master secrets to be used to protect log information generated by the CTRLs in B. The sequence of q+1 different group master secrets may be denoted by: GM₀, GM₁, GM₂, . . . , GM_{q}. q may be a value selected by the system administrator. This value may determine how many system reboots may be done within a domain before new group master secrets are generated. The CMS may set the number of CTRLs in B to be equal to n. The client or CMS may use a suitable S(k,n) threshold secret sharing scheme to securely share the q different master secrets GM₁, GM₂, . . . , GM_{q} into n different shares. In total, q×n different shares may be generated. The n shares for master secret may be denoted by GMⱼ by Sⱼ₁, Sⱼ₂, . . . Sⱼₙ. The CMS, ∀iεB, may generate a secret random index: vᵢ. The CMS, ∀iεB, may generate private public key pair {Prᵢ,Pkᵢ} and corresponding certificate, Certᵢ(Pkᵢ). The certificate may be signed with the system-wide private root-key or by a private key in a public-private key pair that through a certificate chain may be verified by the public root key.

At 1720, at system deployment, ∀iεB, the administrator may request the management client or CMS to transfer the following information to the CTRLᵢ: the GM₀; S₁ᵢ, S₂ᵢ, . . . S_{qi}.; the CTRL specific secret index, vᵢ; a trusted system public root-key (i.e., the key may be used to verify the correctness of the certificate of the CMS for secure connection establishments); the device specific private/public key pair, {Prᵢ,Pkᵢ}, and a corresponding certificate, Certᵢ(Pkᵢ).

At 1730, ∀iεB, the CTRLᵢ may generate three secret keys, such as the current confidentiality key (e.g., common for the whole domain) that may be denoted by KE_{f}, the current domain integrity key, they may be denoted by KIⱼ (e.g., common for the whole domain), and the current device integrity key (e.g., specific for one or more or each CTRL in the domain) that may be denoted by KIᵢⱼₗ, l=0 and as initialization value:

KE₀=PRF(“Domain encryption key”,GM₀),

KI₀=PRF(“Domain integrity key”,GM₀),

KIᵢ₀₀=PRF(“CTRL Integrity key”,GM₀),

where PRF may be a suitable Pseudo Random Function (PRF) that may take length data (e.g. arbitrary length data) as an input.

At 1740, ∀iεB, the CTRLᵢ may store the sequence of shares, S₁ᵢ, S₂ᵢ, . . . S_{qi}, vᵢ, the trusted root key, {Prᵢ,Pkᵢ} and/or Certᵢ(Pkᵢ) in non-volatile memory and/or mark one or more (e.g., all) shares as valid. The CTRLᵢ may set the current valid domain index to, j=0, the current log index to l=0. The CTRLᵢ may store this value in non-volatile memory and may store the following keys: GM₀, KEⱼ, KIⱼ, KIᵢⱼ₀, in volatile memory (RAM) on the device. After one or more (e.g., all) initial key material has been transferred/calculated; ∀iεB, the CTRLᵢ may set its current status to locked.

Log entry generation and storage may be described herein including log generation and protection key update. For example, one or more (e.g., each) CTRL in one or more (e.g., each) domain may keep the current shared secret index synchronized. The current domain index in an arbitrary domain, B, may be denoted by j.

One or more (e.g., each) CTRL in B may generate a sequence of log entries. The sequence of log entries for a particular CTRLᵢ, iεB, may be denoted by Mᵢ₀, Mᵢ₁ . . . , Mᵢₙ.

When new log entries are generated by one or more (e.g., each) CTRLᵢ, they may be transferred to protected log entries. The corresponding sequence of such protected log entry for CTRLᵢ may be denoted by Lᵢ₀, Lᵢ₁ . . . Lᵢₙ. For one or more (e.g., each) new protected log entry that is generated, the CTRL individual integrity key may be updated as:

Kᵢⱼₗ=H(Kᵢⱼₗ₋₁),

where H is a suitable one-way hash function. The CTRL individual integrity key may be updated for one or more (e.g., all) cases, for example, except when a system reboot occurs. The key may be calculated directly from the newly calculated group master secret, for example, as described herein. When this key is updated the old key, Kᵢⱼ₋₁, may be deleted from the device volatile memory.

Log protection format and calculation may be described herein. The log entries produced by CTRLᵢ may have a format and protection mechanism similar (e.g., but not exactly equal) to examples described herein:

Lᵢₗ={j,i,l,E_{KE}_{ⱼ}(B,Mᵢₗ₎),Zᵢₗ},

or in an alternative example

Lᵢₗ={j,i,l,E_{KE}_{ⱼ}(B,Mᵢₗ,Yᵢₗ),Zᵢₗ},

where E_{KE}_{ⱼ}( . . . ) may denote encryption with a suitable symmetric encryption algorithm using the key KEⱼ, and where Zᵢ₁ may be an authentication tag calculated as follows:

If l=0,Zᵢₗ=MAC_{KI}_{ᵢⱼₗ}(B,i,Mᵢₗ),

Otherwise, Zᵢₗ=H(Zᵢₗ₋₁,MAC_{KI}_{ᵢⱼₗ}(Mᵢₗ)),

where MAC_{KI}_{ᵢⱼₗ} may be a suitable MAC algorithm using the symmetric integrity protection key, KIᵢⱼₗ and H may be a suitable one-way hash function. In examples, Yᵢₗ may be encrypted to help avoid local attacks that may attempt to find the log clear text.

The log entries produced by CTRLᵢ may have a format and protection mechanism similar (e.g., but not exactly equal) to examples described herein:

Lᵢₗ={j,i,l,E_{KE}_{ⱼ}(B,Mᵢₗ₎),Yᵢₗ,Zᵢₗ},

where E_{KE}_{ⱼ}( . . . ) may denotes encryption with a suitable symmetric encryption algorithm using the key KEⱼ and where Yᵢₗ may be a hash chain value calculated as follows:

If l=0,Yᵢₗ=H(B,i,Mᵢₗ),

Otherwise, Yᵢₗ=H(Yᵢₗ₋₁,Mᵢₗ),

where H may be a suitable one-way hash function and where the tag value Zᵢₗ may be calculated as:

Zᵢₗ=MAC_{KI}_{ᵢⱼₗ}(Yᵢₗ)),

where MAC_{KI}_{ᵢⱼₗ} may be a suitable MAC algorithm using the symmetric integrity protection key, KIᵢⱼₗ.

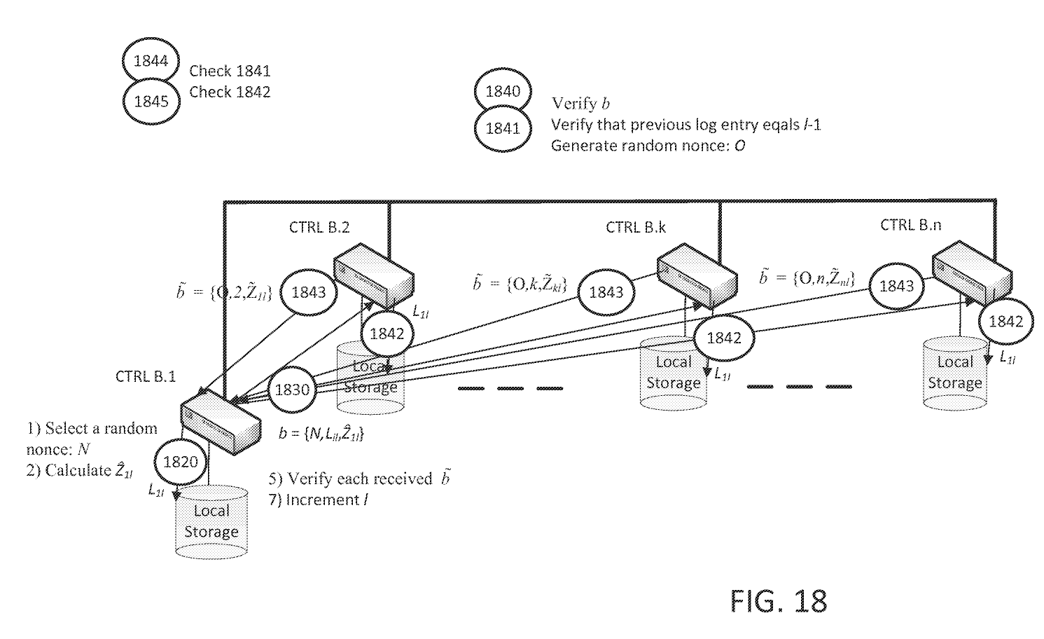

Protection log storage and/or distribution may be provided as described herein. FIG. 18 illustrates an example secure log method that may be provided (e.g., in system 100 or a portion thereof). In examples, one or more (e.g., all) CTRLs within a domain may collaborate to allow for redundant log storage and synchronization. For one or more (e.g., each) new log entry, Lᵢₗ produced by CTRLᵢ, iεB, the log storage procedure and protocol described with respect to FIG. 18 may be utilized. For example, the procedure for i=1 may be illustrated in FIG. 18.

At 1810, the CTRLᵢ may use a good random number source to select a random nonce: N. At 1820, the CTRLᵢ may calculate a second integrity tag as: \hat{Z}ᵢₗ=MAC_{KI}_{ⱼ}(N,Lᵢₗ) and store new log entry, Lᵢₗ in its own non-volatile memory. At 1830, the CTRLᵢ may broadcast the message: b={N, Lᵢₗ, \hat{Z}ᵢₗ}, in the domain B (e.g., in the whole domain B).

At 1840, ∀mεB, m≠i, one or more (e.g., each) CTRLₘ that receives the message sent in 1830 may perform the following. At 1841, the CTRLₘ may verify the integrity of b by calculating the expected MAC for a given B, Lᵢₗ and compare it with the received value \hat{Z}ᵢₗ. At 1842, if the verification was OK, the CTRLₘ may checks the stored logs for unit i in its non-volatile local storage memory and may verify that the last received log entry received from CTRLᵢ equals l−1 and may stores the new log entry in its non-volatile memory. The verification may be utilized to verify that one or more (e.g., all) log entries broadcasted from a particular CTRLᵢ are recorded and that no index is missing. At 1843, tf the check at 1842 was OK, the CTRLₘ may generate a new random nonce, O, and may calculate an integrity check value: \tilde{Z}ₘₗ=MAC_{KI}_{ⱼ}(O,m, \hat{Z}ᵢₗ), and the CTRLₘ may respond to CTRLᵢ with a unicast (UDP) message: \hat{b}={O,m, \tilde{Z}ₘₗ}. At 1844, if the check in 1841 was not OK, the CTRLₘ may respond to CTRLᵢ with a unicast (UDP) error message that may comprise the index m, and the CTRLₘ may store the received protected log message, Lᵢₗ, in non-volatile memory. One or more (e.g., all) log messages from the same unit may be indexed together in the local storage, for example, to make it faster to check if any log message is missing in a log sequence. At 1845, if the check at 1842 was not OK, the CTRLₘ may find the largest index currently stored in memory for CTRLᵢ. The largest index currently stored in memory for CTRLᵢ may be l′<l. The CTRLₘ may broadcast to the domain B asking for one or more (e.g., all) missing entries from l′,l′+1, . . . l−1. This request may be integrity protected under the key KIⱼ. ∀rεB, r≠m, CTRLᵣ (e.g., any CTRL that may receive a request) that may receive the message sent in 1845, and if the find the missing log entries in their non-volatile memory, the CTRLᵣ may respond to CTRLₘ with the missing entries in a unicast message response.

At 1850, the CTRLᵢ may check one or more (e.g., all) received acknowledge messages sent 1843 and the CTRLᵢ may verify the integrity of the message. If less than a pre-defined threshold, k, of OK acknowledge messages arrive, 1830 to 1850 may be repeated.

At 1860, if the CTRLᵢ receive an error indication from one of the units, 1844, it may respond with repeating the message in 1830 and sending a unicast of the same log entry message to that unit.

At 1870, the current valid log entry index for CTRLᵢ, l, may be incremented by one CTRLᵢ and the new current value may be stored in non-volatile memory.

Protected log collection, verification and memory clean up may be described herein. Log information stored distributed in the different domains may be collected (e.g., regularly collected) by the CMS and stored in central location. This may enable the analysis of the log information and may free storage capacity on the CTRLs in the domain that may have limited storage resources.

A sequence of log entries (e.g., or log file) for one or more (e.g. all) CTRLs in a particular domain may be denote by:

L=L̅₁,L̅₂, . . . L̅ₙ=L₁₀,L₁₁, . . . ,L₁ₗ_{₁},L₂₀,L₂₁, . . . ,L₂ₗ_{₂}, . . . ,Lₙ₀,Lₙ₁, . . . ,Lₙₗ_{ₙ}

As described herein, one or more (e.g., all) CTRLs in the domain may stores the complete sequence of log entries for one or more (e.g., all) CTRLs in the domain. The current local copy of this sequence which may be stored by the CTRLᵢ may be denote by Lᵢ.

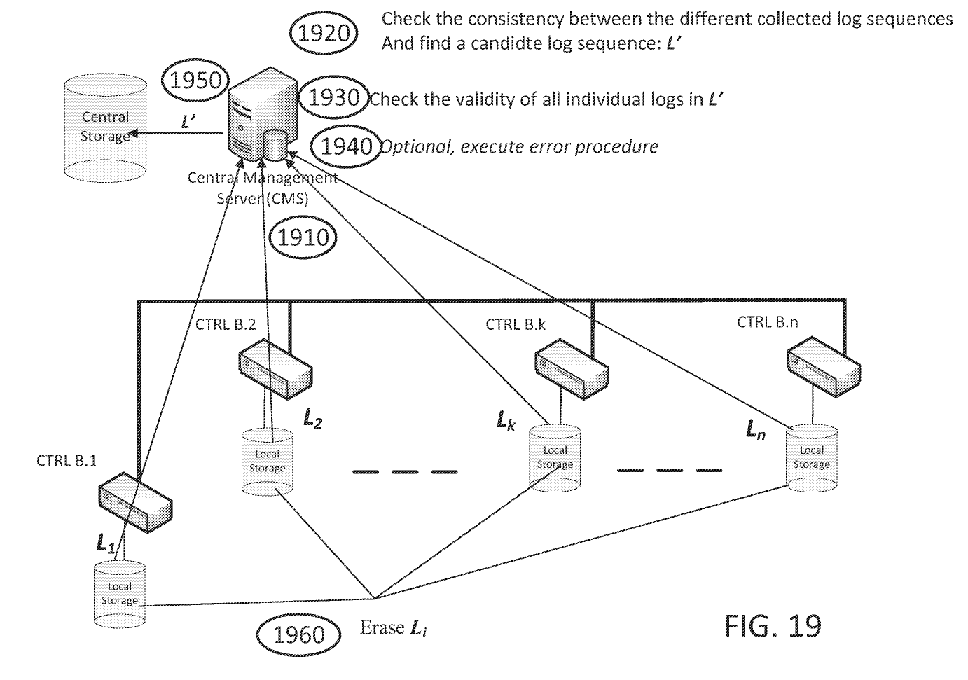

FIG. 19 illustrates an example method for log collection and local memory clean up (e.g., in the system 100 and/or a portion thereof). As described herein, the example illustrated in FIG. 19 may be used for secure log collection and/or verification and/or log entries deletion on the devices.

At 1910, ∀iεB, the CMS may set up a confidentiality and integrity protected connection, such as a TLS with the CTRLᵢ using {Pr_{C},Pk_{C}}, Cert_{CMS}(Pk_{C}), {Prᵢ,Pkᵢ} and Certᵢ(Pkᵢ). One or more (e.g. all) currently stored log entries, Lᵢ, may be retrieved from CTRLᵢ and transferred to the CMS.

At 1920, ∀iεB, the CMS may check the consistency between the different collected log sequences, L̅ᵢ. If more than k complete log sequences are consistent, such that, ∀r, jεB, |B|=k, Lᵣ=Lⱼ, the log sequence may be marked as a valid log file. This log file may be denoted by L′. This log file may be a candidate (e.g., may be completely verified first, at 1930) for being a valid log file to be stored by the CMS. If no such consistent log sequence may be found, an analysis of the log material may be used to find the reason for the inconsistency.

At 1930, the CMS may check the validity of one or more (e.g., all) individual logs in L′. The CMS may load the key GM₀ and calculate the key: KEⱼ=PRF(“Domain encryption key”, GM₀). ∀iεB, The CMS may set l=0 and j=0. The CMS may retrieve, vᵢ, The CMS may calculate the key KIᵢⱼ₀=PRF(“CTRL Integrity key”, GM₀). The CMS may repeat the following until l=lᵢ: checking if the j-index in entry L′ᵢₗ equals j, if not set j=j+1, retrieving master key GMⱼ and calculating new keys as Eⱼ=PRF(Domain encryption key, GMⱼ) and KIᵢⱼₗ=PRF(CTRL Integrity key, vᵢ, GMⱼ); decrypting Mᵢₗ in entry L′ᵢₗ using key KEⱼ; verifying the integrity of entry L′ᵢₗ is by calculating: if l=0, Zᵢₗ=MAC_{KI}_{ᵢⱼₗ}(B, i, Mᵢₗ), otherwise, Zᵢₗ=H (Zᵢₗ₋₁, MAC_{KI}_{ᵢⱼₗ}(Mᵢₗ)), and comparing it with the corresponding integrity value in L′ᵢₗ; verifying the integrity of entry L′ᵢₗ by calculating: if l=0, Yᵢₗ=H(B,i,Mᵢₗ), otherwise, Yᵢₗ=H(Yᵢₗ₋₁,Mᵢₗ), and by calculating Zᵢₗ=MAC_{KI}_{ᵢⱼₗ}(Yᵢₗ), and comparing it with the corresponding integrity value in L′ᵢₗ; setting Kᵢⱼₗ₊₁=H(Kᵢⱼₗ); setting l=l+1 and moving back to repeating said actions.

At 1940, independent of how the CMS verifies the integrity of entry L′ᵢₗ, if a false log entry is detected, one or more (e.g., all) entries following the false log entry for a particular CTRLᵢ may be marked as non-valid and an alarm may be set and the cause of the false log entry generation may be analyzed by the administrator of the system.

At 1950, if one or more (e.g., all) verification attempts were successful, the CMS may store the retrieved validated log file, L′, in a central storage repository.

At 1960, if one or more (e.g., all) verification attempts were successful, the CMS may performs the following: ∀iεB, the CMS may set up a confidentiality and integrity protected connection with CTRLᵢ and request it to delete one or more (e.g., all) the log entries Lᵢ from non-volatile memory; and the CMS may request the CTRLᵢ to change or set the current log entry index to zero, l=0, such that the current integrity key is KIᵢⱼ₀.

System recovery at power loss/reboot may be provide as described herein. Examples described herein may be based on one or more (e.g., all) the keys to protect the log entries being kept in volatile memory. It may be difficult for an attacker to get ahold of the secret keys and the forward security properties may be inherited. There may be a secure procedure to recover/generate valid log protection keys, for example, if the system goes down or if there is temporary loses power.

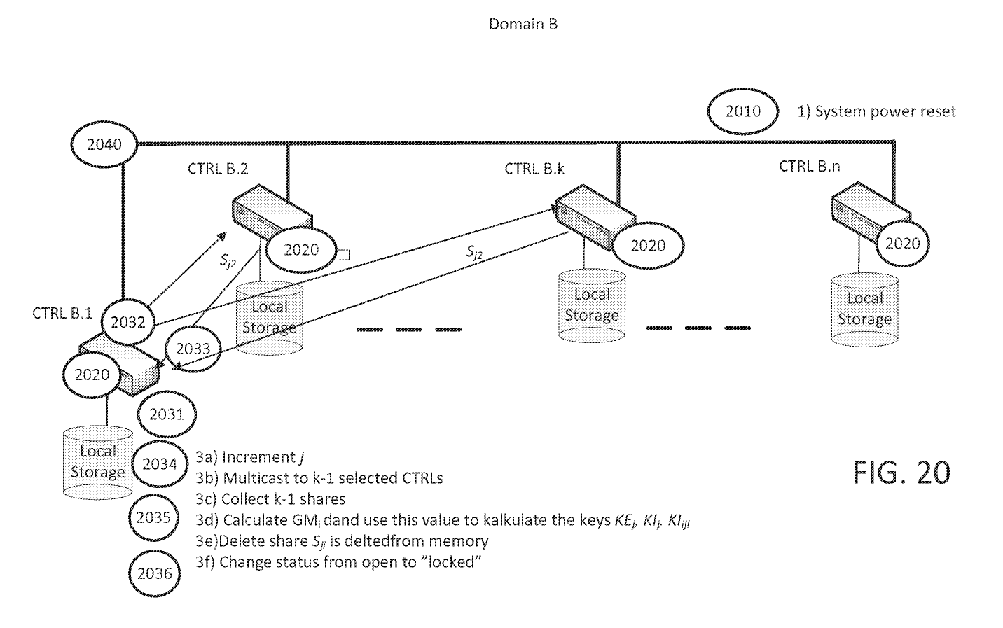

FIG. 20 illustrates an example system recovery procedure or method that may be used in examples. For example, examples herein may describe how keys for log protection are handled when single domain has power loss. A reasonable level of security may be allowed without costly (e.g., from manufacture and maintenance points of view) battery back-up (e.g., except for low power battery back-up) on the CTRLs. One or more (e.g., all) CTRLs within a single domain to recover some or all key material may continue producing valid protected log entries.

At 2010, a domain B may loses its power such that some or all CTRLs lost their power for longer or shorter periods. At 2020, the power may come back ∀iεB and CTRLᵢ may be rebooted and changes its status from locked to open. A domain B may lose its power due to general power loss or due to system maintenance reasons for instance.

At 2030 ∀iεB. At 2031, the CTRLᵢ may read the current valid domain index, j and set the new valid current index to j=j+1. At 2032, the CTRLᵢ may send a multicast message to k−1 selected CTRLs in Ω\vec{∪}B. At 2033, ∀mεΩ, the CTRLₘ may send its current valid share Sⱼₘ back to CTRLᵢ over a mutual authenticated and protected channel. At 2034, the CTRLᵢ may pool the received shares together and may obtain GMⱼ and may use this value, the locally stored secret index value vᵢ, and the current valid log entry index, l, from non-volatile memory, to calculate the following new keys: KEⱼ=PRF(“Domain encryption key”, GMⱼ), KIⱼ=PRF(“Domain integrity key”, GMⱼ), and KIᵢⱼₗ=PRF(“CTRL Integrity key”, GMⱼ). The device integrity key chain may be broken and a new key may be calculated. The old key may have been lost at the reboot and a new integrity key chain may be used. At 2035, the share Sⱼᵢ may be deleted from non-volatile memory. At 2036, the CTRLᵢ may change its status from open to locked. This may not happen immediately. This may happen after a certain period of time, for example, allowing one or more (e.g., all) units in the domain to cover before the system is locked.

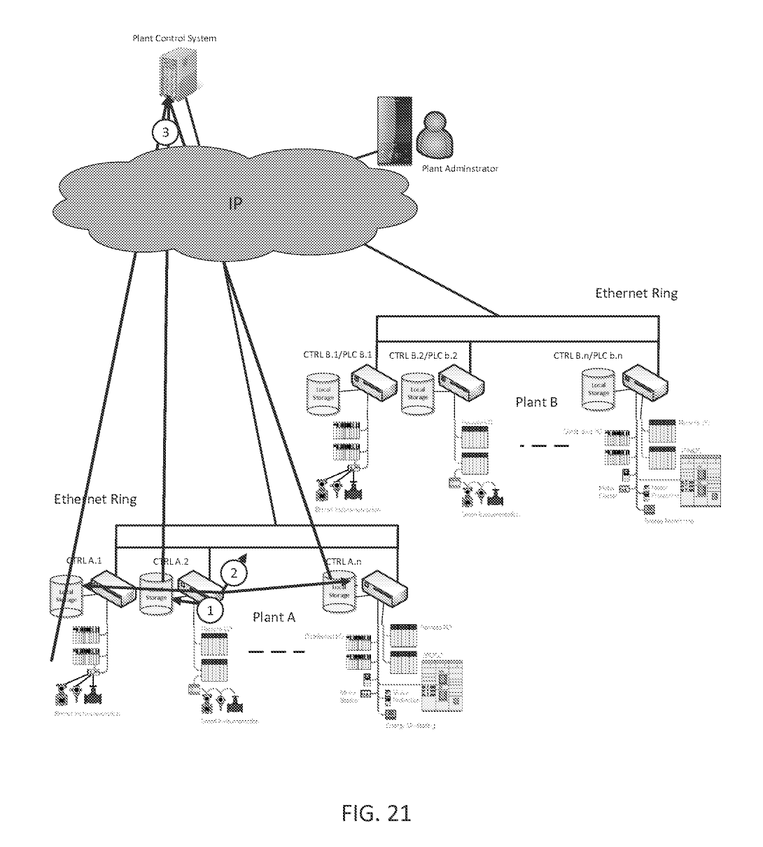

FIG. 21 illustrates an example industrial or manufacturing system that may implement the examples herein. As shown in FIG. 21, at 1, a CTRL (e.g., 104) may log data and may protect the data or entry thereof in a log using or based on a key derived from a domain (e.g., Plant A as shown) wide secret (e.g., described herein above) and an individual secret (e.g., described herein above) in one or more examples. The logged and protected data (e.g., the entry) may be distributed (e.g., broadcast) using an encrypted broadcast within the domain at 2 as described herein. The logged and protected data (e.g., the entry), in an example, at 3, may be sent to a CMS or central system where it may be collected (e.g., stored) and verified therein as described herein.

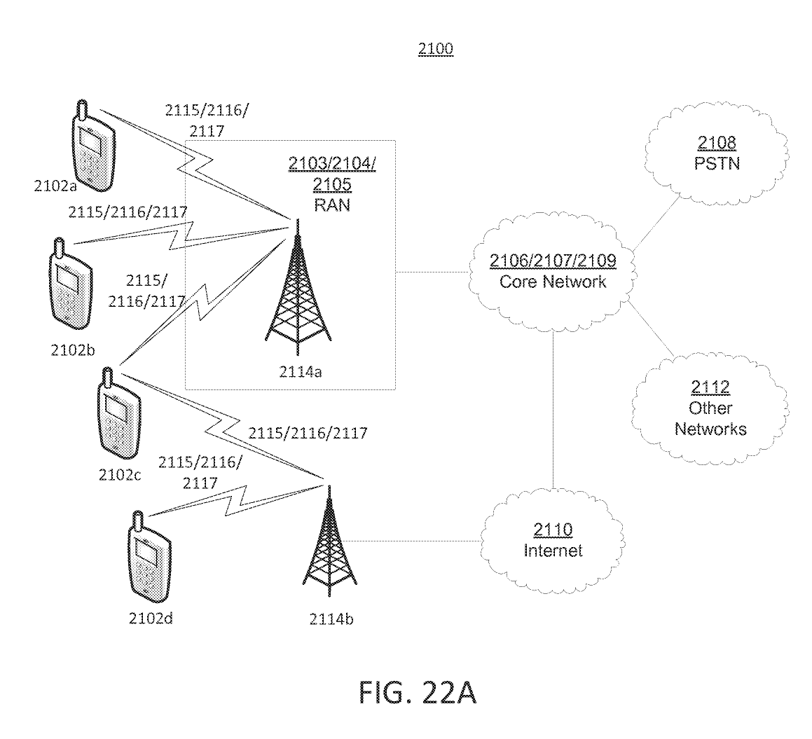

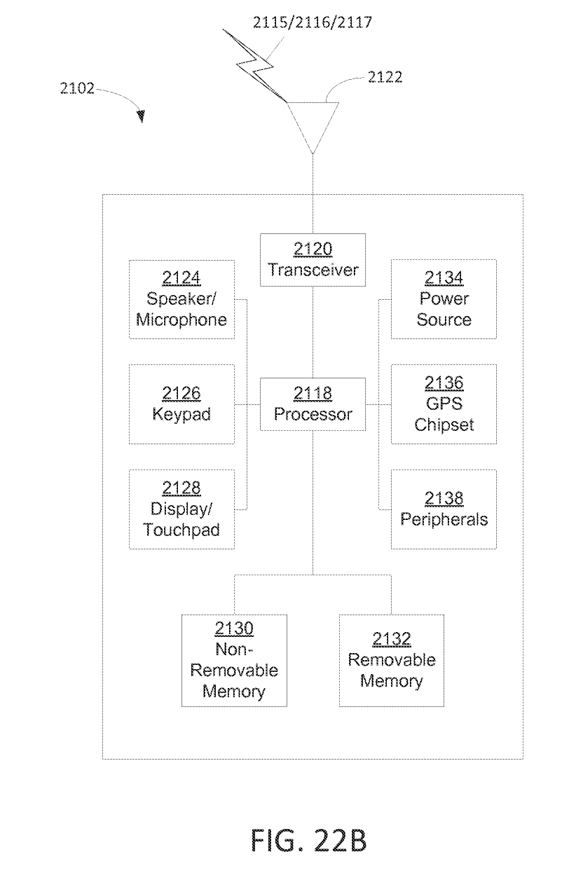

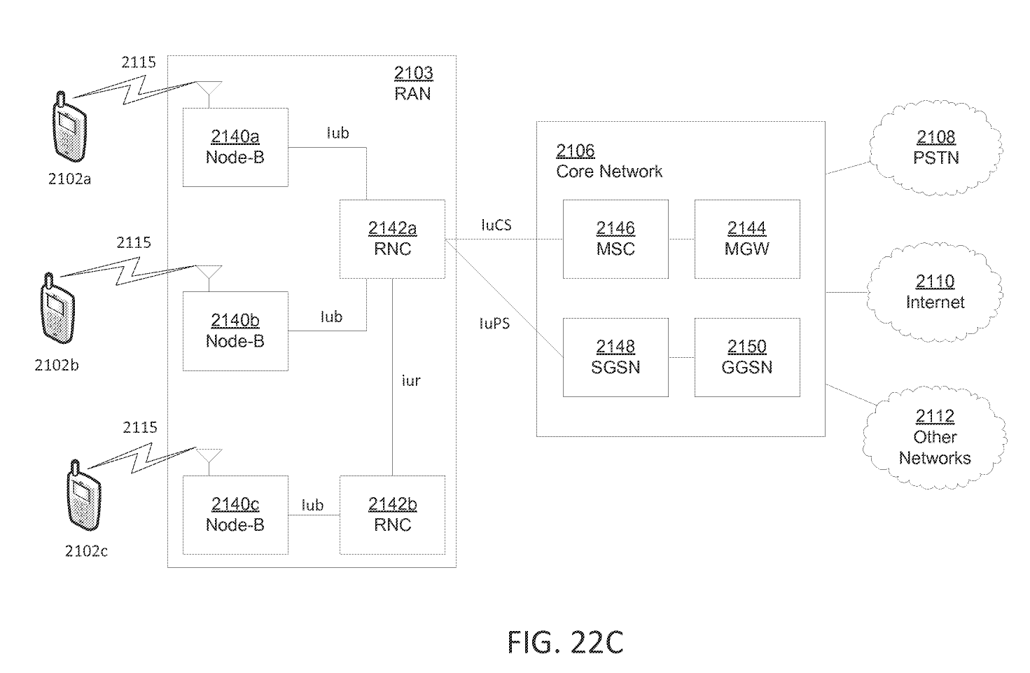

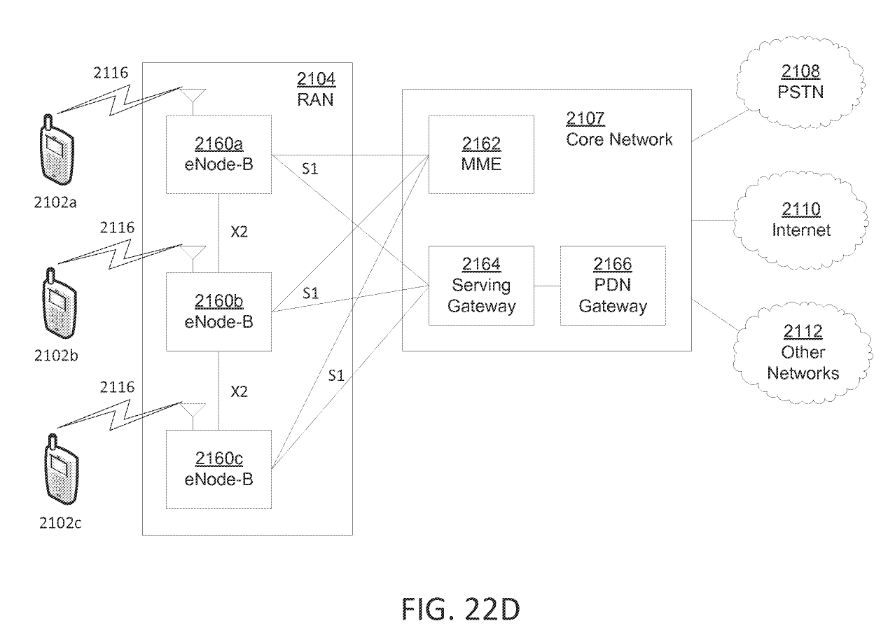

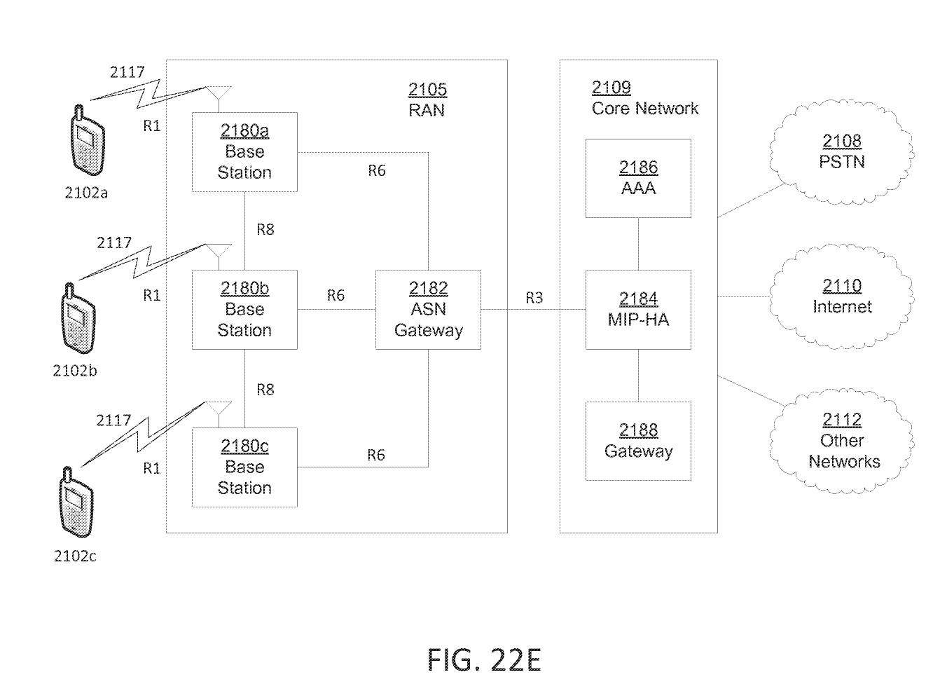

FIG. 22A is a diagram of an example communications system 2100 in which one or more disclosed embodiments may be implemented. The communications system 2100 may be a multiple access system that provides content, such as voice, data, video, messaging, broadcast, etc., to multiple wireless users. The communications system 2100 may enable multiple wireless users to access such content through the sharing of system resources, including wireless bandwidth. For example, the communications systems 2100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 22A, the communications system 2100 may include wireless transmit/receive units (WTRUs) 2102a, 2102b, 2102c, and/or 2102d (which generally or collectively may be referred to as WTRU 2102), a radio access network (RAN) 2103/2104/2105, a core network 2106/2107/2109, a public switched telephone network (PSTN) 2108, the Internet 2110, and other networks 2112, though it will be appreciated that the disclosed embodiments contemplate any number of WTRUs, base stations, networks, and/or network elements. Each of the WTRUs 2102a, 2102b, 2102c, 2102d may be any type of device configured to operate and/or communicate in a wireless environment. By way of example, the WTRUs 2102a, 2102b, 2102c, 2102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 2100 may also include a base station 2114a and a base station 2114b. Each of the base stations 2114a, 2114b may be any type of device configured to wirelessly interface with at least one of the WTRUs 2102a, 2102b, 2102c, 2102d to facilitate access to one or more communication networks, such as the core network 2106/2107/2109, the Internet 2110, and/or the networks 2112. By way of example, the base stations 2114a, 2114b may be a base transceiver station (BTS), a Node-B, an eNode B, a Home Node B, a Home eNode B, a site controller, an access point (AP), a wireless router, and the like. While the base stations 2114a, 2114b are each depicted as a single element, it will be appreciated that the base stations 2114a, 2114b may include any number of interconnected base stations and/or network elements.

The base station 2114a may be part of the RAN 2103/2104/2105, which may also include other base stations and/or network elements (not shown), such as a base station controller (BSC), a radio network controller (RNC), relay nodes, etc. The base station 2114a and/or the base station 2114b may be configured to transmit and/or receive wireless signals within a particular geographic region, which may be referred to as a cell (not shown). The cell may further be divided into cell sectors. For example, the cell associated with the base station 2114a may be divided into three sectors. Thus, in one embodiment, the base station 2114a may include three transceivers, i.e., one for each sector of the cell. In another embodiment, the base station 2114a may employ multiple-input multiple output (MIMO) technology and, therefore, may utilize multiple transceivers for each sector of the cell.

The base stations 2114a, 2114b may communicate with one or more of the WTRUs 2102a, 2102b, 2102c, 2102d over an air interface 2115/2116/2117, which may be any suitable wireless communication link (e.g., radio frequency (RF), microwave, infrared (IR), ultraviolet (UV), visible light, etc.). The air interface 2115/2116/2117 may be established using any suitable radio access technology (RAT).

More specifically, as noted above, the communications system 2100 may be a multiple access system and may employ one or more channel access schemes, such as CDMA, TDMA, FDMA, OFDMA, SC-FDMA, and the like. For example, the base station 2114a in the RAN 2103/2104/2105 and the WTRUs 2102a, 2102b, 2102c may implement a radio technology such as Universal Mobile Telecommunications System (UMTS) Terrestrial Radio Access (UTRA), which may establish the air interface 2115/2116/2117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 2114a and the WTRUs 2102a, 2102b, 2102c may implement a radio technology such as Evolved UMTS Terrestrial Radio Access (E-UTRA), which may establish the air interface 2115/2116/2117 using Long Term Evolution (LTE) and/or LTE-Advanced (LTE-A).

In other embodiments, the base station 2114a and the WTRUs 2102a, 2102b, 2102c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 2114b in FIG. 22A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 2114b and the WTRUs 2102c, 2102d may implement a radio technology such as IEEE 802.11 to establish a wireless local area network (WLAN). In another embodiment, the base station 2114b and the WTRUs 2102c, 2102d may implement a radio technology such as IEEE 802.15 to establish a wireless personal area network (WPAN). In yet another embodiment, the base station 2114b and the WTRUs 2102c, 2102d may utilize a cellular-based RAT (e.g., WCDMA, CDMA2000, GSM, LTE, LTE-A, etc.) to establish a picocell or femtocell. As shown in FIG. 22A, the base station 2114b may have a direct connection to the Internet 2110. Thus, the base station 2114b may not be required to access the Internet 2110 via the core network 2106/2107/2109.

The RAN 2103/2104/2105 may be in communication with the core network 2106/2107/2109, which may be any type of network configured to provide voice, data, applications, and/or voice over internet protocol (VoIP) services to one or more of the WTRUs 2102a, 2102b, 2102c, 2102d. For example, the core network 2106/2107/2109 may provide call control, billing services, mobile location-based services, pre-paid calling, Internet connectivity, video distribution, etc., and/or perform high-level security functions, such as user authentication. Although not shown in FIG. 22A, it will be appreciated that the RAN 2103/2104/2105 and/or the core network 2106/2107/2109 may be in direct or indirect communication with other RANs that employ the same RAT as the RAN 2103/2104/2105 or a different RAT. For example, in addition to being connected to the RAN 2103/2104/2105, which may be utilizing an E-UTRA radio technology, the core network 2106/2107/2109 may also be in communication with another RAN (not shown) employing a GSM radio technology.

The core network 2106/2107/2109 may also serve as a gateway for the WTRUs 2102a, 2102b, 2102c, 2102d to access the PSTN 2108, the Internet 2110, and/or other networks 112. The PSTN 108 may include circuit-switched telephone networks that provide plain old telephone service (POTS). The Internet 2110 may include a global system of interconnected computer networks and devices that use common communication protocols, such as the transmission control protocol (TCP), user datagram protocol (UDP) and the internet protocol (IP) in the TCP/IP internet protocol suite. The networks 2112 may include wired or wireless communications networks owned and/or operated by other service providers. For example, the networks 2112 may include another core network connected to one or more RANs, which may employ the same RAT as the RAN 2103/2104/2105 or a different RAT.

Some or all of the WTRUs 2102a, 2102b, 2102c, 2102d in the communications system 2100 may include multi-mode capabilities, i.e., the WTRUs 2102a, 2102b, 2102c, 2102d may include multiple transceivers for communicating with different wireless networks over different wireless links. For example, the WTRU 2102c shown in FIG. 22A may be configured to communicate with the base station 2114a, which may employ a cellular-based radio technology, and with the base station 2114b, which may employ an IEEE 802 radio technology.

FIG. 22B is a system diagram of an example WTRU 2102. As shown in FIG. 22B, the WTRU 2102 may include a processor 2118, a transceiver 2120, a transmit/receive element 2122, a speaker/microphone 2124, a keypad 2126, a display/touchpad 2128, non-removable memory 2130, removable memory 2132, a power source 2134, a global positioning system (GPS) chipset 2136, and other peripherals 2138. It will be appreciated that the WTRU 2102 may include any sub-combination of the foregoing elements while remaining consistent with an embodiment. Also, embodiments contemplate that the base stations 2114a and 2114b, and/or the nodes that base stations 2114a and 2114b may represent, such as but not limited to transceiver station (BTS), a Node-B, a site controller, an access point (AP), a home node-B, an evolved home node-B (eNodeB), a home evolved node-B (HeNB or HeNodeB), a home evolved node-B gateway, and proxy nodes, among others, may include some or all of the elements depicted in FIG. 22B and described herein.

The processor 2118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 2118 may perform signal coding, data processing, power control, input/output processing, and/or any other functionality that enables the WTRU 2102 to operate in a wireless environment. The processor 2118 may be coupled to the transceiver 2120, which may be coupled to the transmit/receive element 2122. While FIG. 22B depicts the processor 2118 and the transceiver 2120 as separate components, it will be appreciated that the processor 2118 and the transceiver 2120 may be integrated together in an electronic package or chip.

The transmit/receive element 2122 may be configured to transmit signals to, or receive signals from, a base station (e.g., the base station 114a) over the air interface 2115/2116/2117. For example, in one embodiment, the transmit/receive element 2122 may be an antenna configured to transmit and/or receive RF signals. In another embodiment, the transmit/receive element 2122 may be an emitter/detector configured to transmit and/or receive IR, UV, or visible light signals, for example. In yet another embodiment, the transmit/receive element 2122 may be configured to transmit and receive both RF and light signals. It will be appreciated that the transmit/receive element 2122 may be configured to transmit and/or receive any combination of wireless signals.

In addition, although the transmit/receive element 2122 is depicted in FIG. 22B as a single element, the WTRU 2102 may include any number of transmit/receive elements 2122. More specifically, the WTRU 2102 may employ MIMO technology. Thus, in one embodiment, the WTRU 2102 may include two or more transmit/receive elements 2122 (e.g., multiple antennas) for transmitting and receiving wireless signals over the air interface 2115/2116/2117.

The transceiver 2120 may be configured to modulate the signals that are to be transmitted by the transmit/receive element 2122 and to demodulate the signals that are received by the transmit/receive element 2122. As noted above, the WTRU 2102 may have multi-mode capabilities. Thus, the transceiver 2120 may include multiple transceivers for enabling the WTRU 2102 to communicate via multiple RATs, such as UTRA and IEEE 802.11, for example.

The processor 2118 of the WTRU 2102 may be coupled to, and may receive user input data from, the speaker/microphone 2124, the keypad 2126, and/or the display/touchpad 2128 (e.g., a liquid crystal display (LCD) display unit or organic light-emitting diode (OLED) display unit). The processor 2118 may also output user data to the speaker/microphone 2124, the keypad 2126, and/or the display/touchpad 2128. In addition, the processor 2118 may access information from, and store data in, any type of suitable memory, such as the non-removable memory 2130 and/or the removable memory 2132. The non-removable memory 2130 may include random-access memory (RAM), read-only memory (ROM), a hard disk, or any other type of memory storage device. The removable memory 2132 may include a subscriber identity module (SIM) card, a memory stick, a secure digital (SD) memory card, and the like. In other embodiments, the processor 2118 may access information from, and store data in, memory that is not physically located on the WTRU 2102, such as on a server or a home computer (not shown).

The processor 2118 may receive power from the power source 2134, and may be configured to distribute and/or control the power to the other components in the WTRU 2102. The power source 2134 may be any suitable device for powering the WTRU 2102. For example, the power source 2134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 2118 may also be coupled to the GPS chipset 2136, which may be configured to provide location information (e.g., longitude and latitude) regarding the current location of the WTRU 2102. In addition to, or in lieu of, the information from the GPS chipset 2136, the WTRU 2102 may receive location information over the air interface 2115/2116/2117 from a base station (e.g., base stations 2114a, 2114b) and/or determine its location based on the timing of the signals being received from two or more nearby base stations. It will be appreciated that the WTRU 2102 may acquire location information by way of any suitable location-determination implementation while remaining consistent with an embodiment.

The processor 2118 may further be coupled to other peripherals 2138, which may include one or more software and/or hardware modules that provide additional features, functionality and/or wired or wireless connectivity. For example, the peripherals 2138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 22C is a system diagram of the RAN 2103 and the core network 2106 according to an embodiment. As noted above, the RAN 2103 may employ a UTRA radio technology to communicate with the WTRUs 2102a, 2102b, 2102c over the air interface 2115. The RAN 2103 may also be in communication with the core network 2106. As shown in FIG. 22C, the RAN 2103 may include Node-Bs 2140a, 2140b, 2140c, which may each include one or more transceivers for communicating with the WTRUs 2102a, 2102b, 2102c over the air interface 2115. The Node-Bs 2140a, 2140b, 2140c may each be associated with a particular cell (not shown) within the RAN 2103. The RAN 2103 may also include RNCs 2142a, 2142b. It will be appreciated that the RAN 2103 may include any number of Node-Bs and RNCs while remaining consistent with an embodiment.

As shown in FIG. 22C, the Node-Bs 2140a, 2140b may be in communication with the RNC 2142a. Additionally, the Node-B 140c may be in communication with the RNC 2142b. The Node-Bs 2140a, 2140b, 2140c may communicate with the respective RNCs 2142a, 2142b via an Iub interface. The RNCs 2142a, 2142b may be in communication with one another via an Iur interface. Each of the RNCs 2142a, 2142b may be configured to control the respective Node-Bs 2140a, 2140b, 2140c to which it is connected. In addition, each of the RNCs 2142a, 2142b may be configured to carry out or support other functionality, such as outer loop power control, load control, admission control, packet scheduling, handover control, macrodiversity, security functions, data encryption, and the like.

The core network 2106 shown in FIG. 22C may include a media gateway (MGW) 2144, a mobile switching center (MSC) 2146, a serving GPRS support node (SGSN) 2148, and/or a gateway GPRS support node (GGSN) 2150. While each of the foregoing elements are depicted as part of the core network 2106, it will be appreciated that any one of these elements may be owned and/or operated by an entity other than the core network operator.

The RNC 2142a in the RAN 2103 may be connected to the MSC 2146 in the core network 2106 via an IuCS interface. The MSC 2146 may be connected to the MGW 2144. The MSC 2146 and the MGW 2144 may provide the WTRUs 2102a, 2102b, 2102c with access to circuit-switched networks, such as the PSTN 2108, to facilitate communications between the WTRUs 2102a, 2102b, 2102c and traditional land-line communications devices.

The RNC 2142a in the RAN 2103 may also be connected to the SGSN 2148 in the core network 2106 via an IuPS interface. The SGSN 2148 may be connected to the GGSN 2150. The SGSN 2148 and the GGSN 2150 may provide the WTRUs 2102a, 2102b, 2102c with access to packet-switched networks, such as the Internet 2110, to facilitate communications between and the WTRUs 2102a, 2102b, 2102c and IP-enabled devices.

As noted above, the core network 2106 may also be connected to the networks 2112, which may include other wired or wireless networks that are owned and/or operated by other service providers.

FIG. 22D is a system diagram of the RAN 2104 and the core network 2107 according to an embodiment. As noted above, the RAN 2104 may employ an E-UTRA radio technology to communicate with the WTRUs 2102a, 2102b, 2102c over the air interface 2116. The RAN 2104 may also be in communication with the core network 2107.

The RAN 2104 may include eNode-Bs 2160a, 2160b, 2160c, though it will be appreciated that the RAN 2104 may include any number of eNode-Bs while remaining consistent with an embodiment. The eNode-Bs 2160a, 2160b, 2160c may each include one or more transceivers for communicating with the WTRUs 2102a, 2102b, 2102c over the air interface 2116. In one embodiment, the eNode-Bs 2160a, 2160b, 2160c may implement MIMO technology. Thus, the eNode-B 2160a, for example, may use multiple antennas to transmit wireless signals to, and receive wireless signals from, the WTRU 2102a.

Each of the eNode-Bs 2160a, 2160b, 2160c may be associated with a particular cell (not shown) and may be configured to handle radio resource management decisions, handover decisions, scheduling of users in the uplink and/or downlink, and the like. As shown in FIG. 22D, the eNode-Bs 2160a, 2160b, 2160c may communicate with one another over an X2 interface.

The core network 2107 shown in FIG. 22D may include a mobility management gateway (MME) 2162, a serving gateway 2164, and a packet data network (PDN) gateway 2166. While each of the foregoing elements are depicted as part of the core network 2107, it will be appreciated that any one of these elements may be owned and/or operated by an entity other than the core network operator.

The MME 2162 may be connected to each of the eNode-Bs 2160a, 2160b, 2160c in the RAN 2104 via an S1 interface and may serve as a control node. For example, the MME 2162 may be responsible for authenticating users of the WTRUs 2102a, 2102b, 2102c, bearer activation/deactivation, selecting a particular serving gateway during an initial attach of the WTRUs 2102a, 2102b, 2102c, and the like. The MME 2162 may also provide a control plane function for switching between the RAN 104 and other RANs (not shown) that employ other radio technologies, such as GSM or WCDMA.

The serving gateway 2164 may be connected to each of the eNode-Bs 2160a, 2160b, 2160c in the RAN 2104 via the S1 interface. The serving gateway 2164 may generally route and forward user data packets to/from the WTRUs 2102a, 2102b, 2102c. The serving gateway 2164 may also perform other functions, such as anchoring user planes during inter-eNode B handovers, triggering paging when downlink data is available for the WTRUs 2102a, 2102b, 2102c, managing and storing contexts of the WTRUs 2102a, 2102b, 2102c, and the like.

The serving gateway 2164 may also be connected to the PDN gateway 2166, which may provide the WTRUs 2102a, 2102b, 2102c with access to packet-switched networks, such as the Internet 2110, to facilitate communications between the WTRUs 2102a, 2102b, 2102c and IP-enabled devices.

The core network 2107 may facilitate communications with other networks. For example, the core network 2107 may provide the WTRUs 2102a, 2102b, 2102c with access to circuit-switched networks, such as the PSTN 2108, to facilitate communications between the WTRUs 2102a, 2102b, 2102c and traditional land-line communications devices. For example, the core network 2107 may include, or may communicate with, an IP gateway (e.g., an IP multimedia subsystem (IMS) server) that serves as an interface between the core network 2107 and the PSTN 2108. In addition, the core network 2107 may provide the WTRUs 2102a, 2102b, 2102c with access to the networks 2112, which may include other wired or wireless networks that are owned and/or operated by other service providers.

FIG. 22E is a system diagram of the RAN 2105 and the core network 2109 according to an embodiment. The RAN 2105 may be an access service network (ASN) that employs IEEE 802.16 radio technology to communicate with the WTRUs 2102a, 2102b, 2102c over the air interface 2117. As will be further discussed below, the communication links between the different functional entities of the WTRUs 2102a, 2102b, 2102c, the RAN 2105, and the core network 2109 may be defined as reference points.

As shown in FIG. 22E, the RAN 2105 may include base stations 2180a, 2180b, 2180c, and an ASN gateway 2182, though it will be appreciated that the RAN 2105 may include any number of base stations and ASN gateways while remaining consistent with an embodiment. The base stations 2180a, 2180b, 2180c may each be associated with a particular cell (not shown) in the RAN 2105 and may each include one or more transceivers for communicating with the WTRUs 2102a, 2102b, 2102c over the air interface 2117. In one embodiment, the base stations 2180a, 2180b, 2180c may implement MIMO technology. Thus, the base station 2180a, for example, may use multiple antennas to transmit wireless signals to, and receive wireless signals from, the WTRU 2102a. The base stations 2180a, 2180b, 2180c may also provide mobility management functions, such as handoff triggering, tunnel establishment, radio resource management, traffic classification, quality of service (QoS) policy enforcement, and the like. The ASN gateway 2182 may serve as a traffic aggregation point and may be responsible for paging, caching of subscriber profiles, routing to the core network 2109, and the like.

The air interface 2117 between the WTRUs 2102a, 2102b, 2102c and the RAN 2105 may be defined as an R1 reference point that implements the IEEE 802.16 specification. In addition, each of the WTRUs 2102a, 2102b, 2102c may establish a logical interface (not shown) with the core network 2109. The logical interface between the WTRUs 2102a, 2102b, 2102c and the core network 2109 may be defined as an R2 reference point, which may be used for authentication, authorization, IP host configuration management, and/or mobility management.

The communication link between each of the base stations 2180a, 2180b, 2180c may be defined as an R8 reference point that includes protocols for facilitating WTRU handovers and the transfer of data between base stations. The communication link between the base stations 2180a, 2180b, 2180c and the ASN gateway 2182 may be defined as an R6 reference point. The R6 reference point may include protocols for facilitating mobility management based on mobility events associated with each of the WTRUs 2102a, 2102b, 2102c.

As shown in FIG. 22E, the RAN 2105 may be connected to the core network 2109. The communication link between the RAN 2105 and the core network 2109 may defined as an R3 reference point that includes protocols for facilitating data transfer and mobility management capabilities, for example. The core network 2109 may include a mobile IP home agent (MIP-HA) 2184, an authentication, authorization, accounting (AAA) server 2186, and a gateway 2188. While each of the foregoing elements are depicted as part of the core network 2109, it will be appreciated that any one of these elements may be owned and/or operated by an entity other than the core network operator.

The MIP-HA may be responsible for IP address management, and may enable the WTRUs 2102a, 2102b, 2102c to roam between different ASNs and/or different core networks. The MIP-HA 2184 may provide the WTRUs 2102a, 2102b, 2102c with access to packet-switched networks, such as the Internet 2110, to facilitate communications between the WTRUs 2102a, 2102b, 2102c and IP-enabled devices. The AAA server 2186 may be responsible for user authentication and for supporting user services. The gateway 2188 may facilitate interworking with other networks. For example, the gateway 2188 may provide the WTRUs 2102a, 2102b, 2102c with access to circuit-switched networks, such as the PSTN 2108, to facilitate communications between the WTRUs 2102a, 2102b, 2102c and traditional land-line communications devices. In addition, the gateway 2188 may provide the WTRUs 2102a, 2102b, 2102c with access to the networks 2112, which may include other wired or wireless networks that are owned and/or operated by other service providers.

Although not shown in FIG. 22E, it will be appreciated that the RAN 2105 may be connected to other ASNs and the core network 2109 may be connected to other core networks. The communication link between the RAN 2105 the other ASNs may be defined as an R4 reference point, which may include protocols for coordinating the mobility of the WTRUs 2102a, 2102b, 2102c between the RAN 2105 and the other ASNs. The communication link between the core network 2109 and the other core networks may be defined as an R5 reference, which may include protocols for facilitating interworking between home core networks and visited core networks.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, UE, terminal, base station, RNC, and/or any host computer.

1. A method for protecting an integrity of log entries generated by a first device in a distributed system, the method comprising:
receiving, at a first or device associated with a first domain, a first secret key from a central management system;
storing, at the first device, the first secret key in non-volatile memory of the first device;
generating, at the first device, a second secret key using a secure key calculation, the second secret key configured to be shared with a plurality of devices within the first domain;
storing, at the first device, the second secret key in volatile memory of the first device;
generating, at the first unit or device, a first integrity protection key based on the first and second keys;
generating, at a first device, a first broadcast encryption key based on the second key;
generating, at the first device, a security sensitive log entry;
generating, at the first device, an integrity protection tag based on the security sensitive log entry using the first integrity protection key;
generating, at the first device, a protected log entry based on the security sensitive log entry and the integrity protection tag using the first broadcast encryption key; and
broadcasting, at the first unit or device, the protected log entry to the plurality of devices within the first domain.

2. The method according to claim 1, wherein a second device in the first domain receives from the first device the protected log entry and stores the protected log entry in non-volatile local memory.

3. The method according to claim 2, wherein the first device and the second device use a secret sharing scheme to generate the second secret key.

4. The method according to claim 1, wherein the central management system is configured to regularly contact the first device and any other additional device within the domain, collect and verify the integrity and consistency of stored log entries of the first device and any other additional devices within the domain, and store the stored log entries in central protected memory while requesting the first device and any other additional devices in the domain delete locally stored log entries.

5. The method according to claim 1, further comprising:
receiving one or more shares;
broadcasting or sharing the one or more shares with one or more other additional devices within the domain as the first device;
using a secret sharing scheme to generate a third key based on the one or more shares; and
storing the third key in volatile memory.

6. The method of claim 5, wherein the third secret key is configured to replace the second secret key in encryption to protect a security sensitive log entry.

7. The method of claim 6, wherein the third secret key is configured to be generated after the first device has a power failure and reboots.

8. The method of claim 1, wherein the protected log entry is configured to be broadcast using a broadcast message passing.

9. The method of claim 1, wherein generating the integrity protection tag comprises encrypting the security sensitive log entry using the first integrity protection key.

10. The method of claim 1, wherein generating the protected log entry comprises encrypting the security sensitive log entry and the integrity protection tag using the first broadcast encryption key.

11. A device for protecting an integrity of log entries in a distributed system, the device configured at least in part to:
receive a first secret key from a central management system;
store the first secret key in non-volatile memory of the device;
generate a second secret key, the second secret key configured to be shared with a plurality of devices within a domain using a secure key calculation;
store the second secret key in volatile memory of the device;
generate a first integrity protection key based on the first and second keys;
generate a first broadcast encryption key based on the second key;
generate a security sensitive log entry;
generate an integrity protection tag based on the security sensitive log entry using the first integrity protection key;
generate a protected log entry based on the security sensitive log entry and the integrity protection tag using the first broadcast encryption key; and
broadcast the protected log entry to the plurality of devices within the domain

12. The device according to claim 11, further configured to store the protected log entry in non-volatile local memory.

13. The device according to claim 12, wherein the device uses a secret sharing scheme to generate the second secret key.

14. The device according to claim 11, wherein the central management system is configured to regularly contact the device and any other additional devices within the domain, collect and verify the integrity and consistency of stored log entries of the device and any other additional devices within the domain, and store the log entries in central protected memory while requesting the device and any other additional devices in the domain to delete locally stored log entries.

15. The device according to claim 11, further configured to:
receive one or more shares;
broadcast or share the one or more shares with one or more other additional devices within the domain;
use a secret sharing scheme to generate a third key based on the one or more shares; and
store the third key in volatile memory.

16. The device of claim 15, wherein the third secret key is configured to replace the second secret key in encryption to protect a security sensitive log entry.

17. The device of claim 15, wherein the third secret key is configured to be generated after the device has a power failure and reboots.

18. The device of claim 11, wherein the protected log entry is configured to be broadcast using a broadcast message passing.

19. The device of claim 11, wherein generating the integrity protection tag comprises encrypting the security sensitive log entry using the first integrity protection key.

20. The device of claim 11, wherein generating the protected log entry encrypting the security sensitive log entry and the integrity protection tag using the first broadcast encryption key.

21. The device of claim 11, further configured to:
receive, at the first device, protected log entries from one of the plurality of devices within the first domain; and
provide, at the first device, the received protected log entries from the one of the plurality of devices within the first domain to the central management system.

22. The device of claim 21, wherein the device provides the received protected log entries from the one of the plurality of devices within the first domain to the central management system by providing the received protected log entries from the one of the plurality of devices within the first domain to the central management system in an instance the one of the plurality of devices within the domain is unavailable.

23. The device of claim 22, further configured to:
lose, at the first device, connectivity to the central management system; and
reestablish, at the first device, connectivity to the central management system,
wherein the device provides the received protected log entries from the one of the plurality of devices within the first domain to the central management system occurs after reestablishing connectivity to the central management system.

24. The device of claim 21, wherein the device provides the received protected log entries from the one of the plurality of devices within the first domain to the central management system by providing the received protected log entries from the one of the plurality of devices within the first domain as part of a regular collection of log entries by the central management server.

25. The device of claim 11, further configured to:
send a message to the plurality of devices within the domain;
receive a plurality of shared portions of the second secret key;
regenerate the second secret key from the received plurality of shared portions of the second secret key;
retrieve the first secret key from non-volatile storage;
regenerate the first integrity protection key using the first secret key and the regenerated second secret key;
regenerate the first broadcast encryption key using the regenerated second secret key;
generate a second security sensitive log entry;
generate a second integrity protection tag from the second security sensitive log entry using the regenerated first integrity protection key;
generate a second protected log entry from the second security sensitive log entry and the second integrity protection tag using the first broadcast encryption key; and
broadcast the second protected log entry to the plurality of devices within the domain.

26. The device of claim 25, further configured to:
cease to perform processing at the device in response to an unexpected loss of power; and
restart processing at the device,
wherein the device sends the message to a plurality of devices within the domain in response to restarting processing.

27. The method according to claim 1, further comprising:
receiving, at the first device, protected log entries from one of the plurality of devices within the first domain; and
providing, at the first device, the received protected log entries from the one of the plurality of devices within the first domain to the central management system.

28. The method according to claim 27, wherein providing the received protected log entries from the one of the plurality of devices within the first domain to the central management system comprises providing the received protected log entries from the one of the plurality of devices within the first domain to the central management system in an instance the one of the plurality of devices within the domain is unavailable.

29. The method according to claim 28, further comprising:
losing, at the first device, connectivity to the central management system; and
reestablishing, at the first device, connectivity to the central management system,
wherein providing the received protected log entries from the one of the plurality of devices within the first domain to the central management system occurs after reestablishing connectivity to the central management system.

30. The method according to claim 27, wherein providing the received protected log entries from the one of the plurality of devices within the first domain to the central management system comprises providing the received protected log entries from the one of the plurality of devices within the first domain as part of a regular collection of log entries by the central management server.

31. The method of claim 1, further comprising:
sending, at the first device, a message to the plurality of devices within the first domain;
receiving, at the first device, a plurality of shared portions of the second secret key;
regenerating, at the first device, the second secret key from the received plurality of shared portions of the second secret key;
retrieving, at the first device, the first secret key from non-volatile storage;
regenerating, at the first device, the first integrity protection key using the first secret key and the regenerated second secret key;
regenerating, at the first device, the first broadcast encryption key using the regenerated second secret key;
generating, at the first device, a second security sensitive log entry;
generating, at the first device, a second integrity protection tag from the second security sensitive log entry using the regenerated first integrity protection key;
generating, at the first device, a second protected log entry from the second security sensitive log entry and the second integrity protection tag using the first broadcast encryption key; and
broadcasting, at the first device, the second protected log entry to the plurality of devices within the first domain.

32. The method of claim 31, further comprising:
ceasing to perform processing at the first device in response to an unexpected loss of power; and
restarting processing at the first device,
wherein sending the message to a plurality of devices within the first domain is in response to restarting processing.
